(19) United States
(12) Patent Application Publication
(10) Pub. No.: US 2023/0007023 A1
(43) Pub. Date: Jan. 5, 2023

(54) DETECTING ANOMALOUS DIGITAL ACTIONS UTILIZING AN ANOMALOUS-DETECTION MODEL

(71) Applicant: Dropbox, Inc., San Francisco, CA (US)

(72) Inventors: Sarah Andrabi, Seattle, WA (US); Effi Goldstein, Kiryat Ono (IL); Omer Tamir, Tel Aviv (IL); Boris Borshevsky, Tel Aviv (IL)

(21) Appl. No.: 17/364,614

(22) Filed: Jun. 30, 2021

(51) Int. Cl. H04L 29/06; G06N 3/08

(52) U.S. Cl. CPC H04L 63/1425; G06N 3/08

(57) ABSTRACT

This disclosure describes embodiments of systems, methods, and non-transitory computer readable storage media that utilize a machine-learning model to detect mass file deletions, mass file downloads, ransomware encryptions, or other anomalous digital events within a digital-content-synchronization platform. For example, the disclosed systems can monitor digital actions executed across a digital-content-synchronization platform in real (or near-real) time and use a machine-learning model to analyze features of such digital actions to distinguish and detect anomalous actions. Upon detection, the disclosed systems can alert a client device of the anomalous actions with an explanatory rationale and, in some cases, perform (or provide options to perform) a remedial action to neutralize or contain the anomalous actions. Furthermore, the disclosed systems can also modify the machine-learning model based on interactions received from an administrator device in response to the anomalous actions.

### BACKGROUND

In recent years, online or “cloud” storage systems have increasingly stored and managed electronic media generated via client devices. For instance, some existing document hosting systems provide tools for multiple users to create, modify, delete, and share electronic media within a document or file synchronizing environment. By providing web-based tools for such document and file synchronization, many existing document hosting systems enable multiple users to retrieve, view, and modify a number of electronic media that is synchronized between the client devices of the multiple users. Many of these existing systems receive large numbers of actions (e.g., hundreds of thousands or millions) from a substantial number of users (e.g., hundreds of thousands or millions) on a substantial number of stored electronic media (e.g., hundreds of thousands or millions). Although existing document hosting systems allow users to store, access, and manipulate electronic media on a large scale, these existing systems exhibit several technical shortcomings. As described further below, existing document hosting systems utilize anomaly detection algorithms that inhibit identifying mass document or file deletions, malware or ransomware infiltrations, mass document or filing sharing, or other malicious or accidental actions that compromise the data security of a system.

For example, many existing document hosting systems fail to effectively identify or detect accidental or deliberate digital actions that compromise data security within large scale synchronizing environments. When a large number of users interact with an increasingly large number of electronic media, current systems often lack computational models that can identify security-compromising events within the synchronizing system. Due in part to the large number of users storing, accessing, and manipulating various amounts of electronic media in very different ways, existing document hosting systems cannot effectively distinguish between malicious actions or accidental actions that pose data-security risks, on the one hand, from merely infrequent or unusual actions that do not pose a data-security risk, on the other hand.

In addition to the high volume of various digital actions obscuring security-compromising events, current systems often times cannot detect malicious actions and accidental actions due to the decentralized nature of some digital actions taken by computing devices outside existing document hosting systems. Specifically, many existing systems receive data representing digital actions from various client devices associated with users that often interact with the same electronic media—without the current document hosting system having control of (or access to) the various client devices. Such lack of control or access complicates the existing system's functions of tracking or identifying malicious actions and accidental actions. Accordingly, many existing systems experience data loss or data mismanagement due to ineffective measures for identifying and handling data security issues.

To further illustrate, existing document hosting systems often inaccurately detect malicious actions and accidental actions within large synchronizing environments. For example, many existing systems utilize rigid computational models that detect a high number of false negatives and/or false positives for the malicious and accidental actions. Because the high volume of non-anomalous actions bury or obscure anomalous actions within these synchronizing environments—and some existing computational models apply rigid thresholds across different user accounts—existing systems often do not recognize a pattern of digital actions that together may compromise data security (e.g., a user incrementally downloading sensitive documents over time). Conversely, when computational models rigidly adhere to low security thresholds, existing systems identify a high number of false positive situations that data security specialists or other document-hosting-recipient users learn to ignore, as existing systems routinely flag many non-anomalous actions as malicious and/or accidental.

In addition to failing to detect or distinguish security-compromising events, many existing document hosting systems cannot intelligently react to malicious digital actions and accidental digital actions while digital actions occur in real time (or shortly thereafter) within a synchronizing environment. For instance, existing document hosting systems often do not identify or detect malicious digital actions and digital accidental actions until after the digital actions are fully executed and data is compromised. Furthermore, upon full execution of a security-compromising action, many existing systems rely upon user intervention to resolve (or recover) from the effects of the malicious digital actions and accidental digital actions that pose security risks.

### SUMMARY

This disclosure describes one or more embodiments of systems, methods, and non-transitory computer readable storage media that provide benefits and/or solve one or more of the foregoing and other problems in the art. For instance, the disclosed systems can utilize a machine-learning model to detect mass file deletions, mass file downloads, ransomware encryptions, or other anomalous digital events within a digital-content-synchronization platform. In particular, the disclosed systems can monitor digital actions executed across a digital-content-synchronization platform in real (or near-real) time and use a machine-learning model to analyze features of such digital actions to distinguish and detect anomalous actions. Upon detection, the disclosed systems can alert a client device of the anomalous actions with an explanatory rationale and, in some cases, perform (or provide options to perform) a remedial action to neutralize or contain the anomalous actions. In one or more embodiments, the disclosed systems detect mass file deletions, mass file downloads, ransomware encryptions, or other anomalous digital events within the digital-content-synchronization platform in various circumstances (e.g., based on changes in activities for different times as observed in historical data).

For example, the disclosed systems can identify a digital action taken by a client device associated with a user of a content management system. Then, the disclosed systems can determine parameters of the digital action (in real or near-real time) to input into an anomaly-detection model trained to detect anomalous actions. Based on the input parameters, the anomaly-detection model can generate an anomaly indicator predicting whether the digital action is anomalous. In some embodiments, for instance, the disclosed systems monitor (and input into the anomaly-detection model) parameters that indicate the type of digital action, a number of affected files, file sizes, a location of the acting user, a time of the digital action, collaborator data corresponding to the user, user-device type, user-account type, and/or a user role of the user. Based on the generated anomaly indicator, the disclosed systems can provide an electronic alert to indicate the digital action as anomalous, perform a remedial action within the content management system in response to the anomalous action, and/or modify the anomaly-detection model based on interactions received from an administrator device in response to the anomalous action.

### BRIEF DESCRIPTION OF THE DRAWINGS

The detailed description is described with reference to the accompanying drawings in which:

FIG. 1 illustrates a schematic diagram of an example system in which the anomalous-event-detection system operates in accordance with one or more implementations.

FIG. 2 illustrates an overview of the anomalous-event-detection system detecting and utilizing an anomalous action in accordance with one or more implementations.

FIG. 3 illustrates the anomalous-event-detection system identifying a digital action from a knowledge graph in accordance with one or more implementations.

FIG. 4 illustrates the anomalous-event-detection system detecting an anomalous action utilizing an unsupervised-anomaly-detection model in accordance with one or more implementations.

FIG. 5 illustrates the anomalous-event-detection system detecting an anomalous action utilizing a neural-network-based-anomaly detection model in accordance with one or more implementations.

FIG. 6 illustrates the anomalous-event-detection system performing one or more remedial actions in response to a detected anomalous action in accordance with one or more implementations.

FIG. 7 illustrates the anomalous-event-detection system modifying an anomaly-detection model based on responses to anomalous actions in accordance with one or more implementations.

FIG. 8 illustrates a computing device displaying a graphical user interface comprising anomalous action alerts in accordance with one or more implementations.

FIG. 9 illustrates a computing device displaying a graphical user interface comprising selectable options to configure alerts and automatic remedial actions in accordance with one or more implementations.

FIG. 10 illustrates the anomalous-event-detection system selecting between anomaly-detection models in accordance with one or more implementations.

FIG. 11 illustrates a flowchart of a series of acts for detecting and reacting to anomalous digital actions in accordance with one or more implementations.

FIG. 12 illustrates a block diagram of an exemplary computing device in accordance with one or more implementations.

FIG. 13 illustrates an example environment of a networking system in accordance with one or more implementations.

### DETAILED DESCRIPTION

This disclosure describes one or more embodiments of an anomalous-event-detection system that utilizes a machine-learning model to detect anomalous actions within a content management system. For instance, the anomalous-event-detection system can use a machine-learning anomaly-detection model trained to analyze parameters of digital actions executed across a digital-content-synchronization platform to detect anomalous actions amongst such digital actions. When the anomaly-detection model detects anomalous actions, the anomalous-event-detection system can transmit an alert to client device identifying the detected anomalous actions and (in some cases) automatically performs remedial actions to counteract the anomalous actions. In certain instances, the anomalous-event-detection system also or alternatively provides the client device with selectable options to initiate remedial actions or to discontinue an automatically initiated remedial action.

For instance, the anomalous-event-detection system can identify a digital action taken by a client device associated with a user account of a content management system. Upon identifying the digital action, the anomalous-event-detection system can determine parameters corresponding to the digital action. Based on the parameters, an anomaly-detection model trained to detect anomalous actions can generate an anomaly indicator that the digital action is an anomalous action. Based on the anomaly indicator, the anomalous-event-detection system can display (e.g., on an administrator device) an electronic communication that indicates the digital action as anomalous, perform or provide options to perform a remedial action in response to the anomalous action, and/or utilize data received from the administrator device in response to the electronic communication to modify anomaly-detection model. In some embodiments, the anomalous-event-detection system also provides context information (and visual previews) that indicate or expain why a digital action is anomalous.

As noted above, the anomalous-event-detection system can identify digital actions taken within a content management system. In some instances, the anomalous-event-detection system identifies digital actions with parameters that include a type of digital action, a number of affected files, a file size, a user location, a time of the digital action, collaborator data, and/or a user role of the user account. To identify such parameters, in one or more embodiments, the anomalous-event-detection system identifies the digital actions from a knowledge graph that includes and connects information from multiple sources (or components) of a content management system for user information, digital content information, and digital action events occurring within the content management system.

Based on the determined parameters of the digital actions, the anomalous-event-detection system can utilize an anomaly-detection model to detect anomalous actions. In many instances, the anomalous-event-detection system utilizes a machine-learning model that is trained as an anomaly-detection model to identify anomalous actions from parameters of digital actions. For example, the anomalous-event-detection system can utilize a neural network that is trained to classify a digital action as anomalous and/or non-anomalous based on the parameters of the digital action. In certain embodiments, the anomalous-event-detection system utilizes a clustering model and/or a random forest model to detect that a digital action is an anomalous action from parameters of the digital action.

Upon detecting an anomalous action and in response to the anomalous action, in some embodiments, the anomalous-event-detection system automatically performs (or provides selectable options to an administrator device for performing) a remedial action to neutralize or contain an anomalous action. For instance, the anomalous-event-detection system can automatically recover a deleted digital content item, restrict a user account corresponding to the user that performed the anomalous action from performing additional digital actions, modify a user permission of the user account, and/or automatically prevent a data synchronization of digital content between client devices and a content management system. In some cases, the anomalous-event-detection system can provide, within an administrator device, selectable options to cancel a remedial action that was automatically performed by the anomalous-event-detection system.

In some instances, after detecting an anomalous action, the anomalous-event-detection system can provide an electronic communication to an administrator device to indicate that an anomalous action has been detected. For example, the anomaly-detection model can detect and send an alert (via an electronic communication) for anomalous actions such as, but not limited to, anomalous file deletions, anomalous file shares, anomalous file creations, anomalous file modifications, anomalous user role modifications, and/or anomalous file decryption. As part of the electronic communication, the anomalous-event-detection system can also provide context for the anomalous action (e.g., the user that performed the digital action, a time of the digital action, a reason for identifying the digital action as anomalous). As also part of the electronic communication, the anomalous-event-detection system can provide selectable options to respond to the anomalous action (e.g., select a remedial action to perform).

To determine whether to transmit an alert about a detected anomalous action, in some embodiments, the anomalous-event-detection system determines and compares a severity level and a sensitivity level corresponding to an anomaly indicator to an alert threshold. For example, the anomalous-event-detection system can determine a severity level indicating the importance (e.g., the impact or harmfulness) of an anomalous action based on historical data with alerts for similarly detected anomalous actions. Moreover, the anomalous-event-detection system can determine a sensitivity level indicating if the anomaly-detection model detected an anomalous action with a threshold confidence prior to transmitting an anomalous action alert or performing a remedial action.

In addition to alerts or remedial actions, in some embodiments, the anomalous-event-detection system utilizes the data received from an administrator device to modify the anomaly-detection model. More specifically, in one or more embodiments, the anomalous-event-detection system receives indications of which selectable options (as the data) were selected from the administrator device. Based on the received selections to respond or ignore the detected anomalous action, the anomalous-event-detection system can modify the anomaly-detection model (e.g., adjust settings of the model, adjust machine learning parameters of the model). In particular, in one or more embodiments, the anomalous-event-detection system utilizes data (e.g., interactions) received from administrator devices responding to detected anomalous actions as training data (e.g., labels for the training data) for the anomaly-detection model.

For example, the anomalous-event-detection system can modify the anomaly-detection model to deemphasize detection of a particular type of digital action (e.g., a file deletion) as an anomalous action when the administrator device disregards the anomalous action alert or cancels a remedial action taken for the detected anomalous action. Similarly, in certain implementations, the anomalous-event-detection system adjusts or learns sensitivity levels based on responses by the administrator device to anomalous action alerts, including no response or specific actions addressing anomalous actions indicated in alerts. Also, in some instances, the anomalous-event-detection system can modify the anomaly-detection model to emphasize (or bolster) detection of a particular type of file deletion (e.g., mass deletion above a threshold number for a user) as an anomalous action when the administrator device indicates a selection to recover the particular file deletion or confirms an automatic remedial action taken for the detected anomalous action.

The anomalous-event-detection system provides several technical advantages over existing document hosting systems. For example, the anomalous-event-detection system can effectively detect accurate anomalous actions (e.g., malicious or accidental actions) amongst a large number of digital actions taken by numerous users in a large-scale digital-content-synchronization platform. In particular, unlike existing systems that detect a high number of false negative and false positive malicious and accidental actions within a decentralized synchronizing environment, the anomalous-event-detection system can adaptively learn (e.g., machine learn) to accurately detect anomalous actions. For example, by training (and continuously updating) a machine learning model to detect anomalous actions from parameters of digital actions monitored in real (or near-real) time using administrator device feedback on detected anomalies, the anomalous-event-detection system can reduce false negative and false positive detections.

As noted above, some existing systems cannot accurately detect anomalous actions among high volumes of non-anomalous actions executed within a digital-content-synchronization platform. By contrast, the anomalous-event-detection system can accurately detect anomalous actions even with a high volume of non-anomalous actions that obscure anomalous actions within digital-content-synchronization platforms. By utilizing a trained anomaly-detection model with improved anomaly-detection accuracy, the anomalous-event-detection system can detect and provide actionable alerts for anomalous actions without the system being overwhelmed with false positive and false negative detections.

In addition to improved anomaly-detection accuracy, in some embodiments, the anomalous-event-detection system executes self-healing actions to counteract anomalous actions endangering data security. By detecting anomalous actions and initiating actions in response to the detected anomalous actions within a content management system, the anomalous-event-detection system can provide a practical data security application that can self-heal within a high volume digital-content-synchronization platform. In contrast to existing systems that fail to detect and prevent full execution of many or most anomalous actions in a synchronizing environment, the anomalous-event-detection system can automatically initiate remedial actions that prevent the full execution of detected anomalous actions that compromise data security. For instance, in some cases, the anomalous-event-detection system determines a sensitivity level and a severity level for a detected anomalous action to trigger automatic remedial actions that prevent damaging data and/or neutralize predicted anomalous actions. As an example, upon detecting an anomalous mass deletion of files, the anomalous-event-detection system can initiate an automatic remedial action to terminate the deletion of files such that the anomalous mass deletion action is contained or neutralized. As a further example, upon detecting a client device mass shares a large number of files with a computing device of an external entity—an entity with which the file-source organization has not previously shared files—the anomalous-event-detection system 106 can initiate an automatic remedial action to block the client device from sharing the files (e.g., at least until an approval is received from an administrator device).

Beyond remedial actions that improve data security, in some embodiments, the anomalous-event-detection system implements a first-of-its-kind machine learning model with a unique set of parameters. For instance, the anomalous-event-detection system can extemporaneously identify and analyze digital action parameters that indicate the type of digital action, a number of affected files, file sizes, a location of the acting user, a time of the digital action, collaborator data corresponding to the user, type of client device, a type of application utilized on the client device to initiate the digital action, and/or a user role of the user to quickly detect anomalous actions posing data-security risks. In contrast to many existing systems, the anomalous-event-detection system can monitor the above-mentioned parameters of digital actions in real (or near-real) time to provide input to the machine learning model to generate anomaly indicators while also adaptively learning from user interactions with the generated anomaly indicators. Accordingly, the anomalous-event-detection system can generate and utilize a unique machine learning model that specializes in the detection of anomalous actions in a digital-content-synchronization platform. Unlike existing systems that utilize rule-based anomalous event detectors that cannot detect newly introduced anomalous actions, the unique machine learning model can adapt to predict and detect anomalous actions from newly introduced digital actions.

As illustrated by the foregoing discussion, the present disclosure utilizes a variety of terms to describe features and benefits of the anomalous-event-detection system. Additional detail is now provided regarding the meaning of these terms. As used herein, the term “digital action” refers to a digital command or digital event that results in a change of a state of data, such as a digital document or digital file. For example, a digital action can include a digital command or digital event to select and/or manipulate data by changing properties of data, the location of data, associations with data, and/or the content of data. To illustrate, a digital action can include, but is not limited to, a deletion of digital content, a modification of digital content (e.g., editing an image or document, folder hierarchies), a relocation of digital content (e.g., duplicating a file, moving a file), a sharing of digital content (e.g., sharing a digital content item with a collaborator and/or other entity), a setting and/or preference modification (e.g., changing system settings, user roles or permissions), a creation of digital content, or an electronic communication transmission (e.g., sending an e-mail, instant message, comment).

In some cases, a digital action or series of digital actions can be taken by a client device via a document-synchronizing platform. As used herein, the term “document-synchronizing platform” refers to a set of software components or applications that operate to host and/or synchronize digital documents. For example, a document-synchronizing platform can include software components and applications comprising tools for multiple user accounts to access, edit, share, or synchronize digital documents, such as by synchronizing revisions or comments to a digital document accessible by multiple user accounts—such that revisions or comments can be viewed in real (or near-real) time by the multiple user accounts. In some cases, a document-synchronizing platform may include server devices that execute a specific software language or machine language code and also run a type of software or suite of compatible software applications for hosting and synchronizing digital documents accessible to multiple user accounts. A document-synchronizing platform may likewise use a data model that is specific to the document-synchronizing platform and that specifies data formats (e.g., document file types) for storing, sending, and receiving data. In some cases, the document-synchronizing platform can include a software component and/or application that performs a specific function (e.g., synchronizing comments or revisions to digital documents) within an overarching computing system (e.g., the content management system) that receives, analyzes, and/or communicates various components of digital documents.

Furthermore, as used herein, the term “parameter” refers to a characteristic or attribute of a digital action or a user account initiating the digital action. In particular, a parameter can include a signal and/or data value (e.g., numerical and/or text) that indicates a characteristic or attribute of a digital action or the user account. In one or more embodiments, a parameter provides a characteristic or context related to the occurrence of a digital action, the actors involved with the digital action, and/or the digital content (or other digital object) affected by the digital action. For example, a parameter can include, but is not limited to, a type of digital action, a number of affected files, a file size, a file type, a user location, a time of digital action, collaborator data (e.g., collaborator activity, collaborator identity), a user role, a personal identifiable information (PII) classification type, a confidentiality classification, a time zone, a time of user interactivity with a digital content item, historical user activity times within the digital content management system, user engagement data, a user device type, a user e-mail domain, user group similarity data, user activity patterns, user IP addresses, a user device type, or a type of application utilized to initiate a digital action. In some embodiments, a parameter can also include data from a third-party data security application (e.g., threat intel from internet service providers, virus detection applications, data security alerts).

As further used herein, the term “digital content item” refers to a discrete data representation of a document, file, or image. In particular, a digital content item can include, but is not limited to, a digital image, a digital video, an electronic document (e.g., text file, spreadsheet, PDF), and/or electronic communication. In addition, digital content can include data such as, but not limited to, user settings, user permissions, content sharing settings.

Additionally, as used herein, the term “anomaly indicator” refers to a data object that includes metrics or text to identify or indicate a probability for whether a digital action is anomalous. For instance, an anomaly indicator can include an anomaly-detection model output that can indicate a digital action as an anomalous action or can provide a value that indicates a likelihood of a digital action being an anomalous action. To illustrate, in some instances, the anomaly indicator can include various types of anomalous actions and a confidence score (e.g., a numerical value) that indicates the likelihood of a digital action being a particular type of anomalous action. For example, the anomaly-detection model can generate the anomaly indicator to include a confidence score of 0.85 for an anomalous deletion action indicating that the digital action is likely to be an anomalous deletion action. Furthermore, the anomaly-detection model can generate the anomaly indicator to include a confidence score of 0.05 for an anomalous share action indicating that the digital action is not likely to be an anomalous share action.

As used herein, the term “anomalous action” refers to a digital action that is inconsistent with (or an outlier with respect to) a normal dataset (e.g., normal behavioral data) for a set of digital actions. For example, an anomalous action can include a digital action that is inconsistent with (or differs from an expected range for) other digital actions within a set of circumstances (e.g., at an individual user account level, at a user group level, at an organizational level, or within a specific industry corresponding to a user account). Similarly, a set of anomalous actions can include digital actions that are inconsistent with (or differs from an expected range for) other digital actions within a set of circumstances. In some embodiments, an anomalous action can include a digital action that is predicted to pose a data-security risk as determined by a machine-learning model. For example, the anomalous action can include an anomalous file deletion, an anomalous file share, an anomalous file creation, an anomalous file modification, an anomalous user role modification, an anomalous file decryption (or encryption), an anomalous file download (e.g., downloading an unusual amount of files, downloading files outside of the content management system into another device).

As also used herein, the term “context for identifying a digital action as anomalous” refers to information explaining or providing a reason for classifying or identifying a digital action as anomalous or explaining the circumstances of the digital action identified as anomalous. To illustrate, context can include information of a user account corresponding to the anomalous action, a time of the anomalous action, a reason for identifying the digital action as anomalous, or information describing or identifying historical behavior of the user account (e.g., historically normal behavior of a user).

Furthermore, as used herein, the term “anomaly-detection model” refers to a machine-learning model that can be adjusted or has been trained to detect (or predict or classify) the presence of an anomalous action based on parameters (or signals) of a digital action or group of digital actions. In certain instances, the anomalous-event-detection system modifies (e.g., configures or trains) an anomaly-detection model to classify a digital action as anomalous or not anomalous. For instance, an anomaly-detection model can include a machine learning model that includes a neural network. In some instances, the anomaly-detection model can include a machine learning model that includes a clustering model, a random forest model, or other types of machine learning models or combinations thereof.

In some embodiments, an anomaly-detection model includes a number of concatenated machine-learning models. To illustrate, in some instances, the anomalous-event-detection system can utilize an anomaly-detection model that receives input from various other models (in addition to parameter for a target digital action). For instance, the anomalous-event-detection system can utilize one or more machine-learning models that generate scores for specific characteristics corresponding to digital actions based on parameter inputs. More specifically, the anomalous-event-detection system can utilize an initial machine-learning model to determine characteristics, such as, but not limited to, whether a digital action was taken during normal activities times of a user account (e.g., normal business hours, normal access hours), whether the digital action corresponds to a normal number of files, whether the digital action corresponds to a normal size of files, whether the digital action corresponds to a normal type of files, or whether the digital action corresponds to a normal client device utilized by the user account. The anomalous-event-detection system can subsequently input one or more scores from one or more such initial machine-learning models (with other parameters for a digital action) into a subsequent machine-learning model to generate an anomaly indicator (e.g., a final anomaly score).

Additionally, as used herein, the term “neural network” refers to a machine learning algorithm that can be tuned (e.g., trained) based on training inputs to estimate an unknown function. In particular, a neural network can include a plurality of interconnected artificial neurons that transmit data to other artificial neurons that generate outputs based on one or more inputs. More specifically, the plurality of interconnected neurons can learn to estimate complex elements by utilizing prior estimations and other training data. For example, a neural network can include deep neural networks, convolutional neural networks (“CNN”), fully convolutional neural networks (“FCN”), or recurrent neural networks (“RNN”).

Furthermore, as used herein, the term “remedial action” refers to a digital action taken to limit, respond to, prevent, or terminate a detected anomalous action. In particular, a remedial action can include a reactionary action to a digital action that was detected to be an anomalous action. Specifically, the remedial action can counteract the anomalous action or prevent further change as a result of the anomalous action or from a user account that initiated the anomalous action. For example, a remedial action can include a recovery of a deleted or modified digital content item, restriction of a user account corresponding to an anomalous action from performing additional digital actions, and/or a modification of a user permission of the user account.

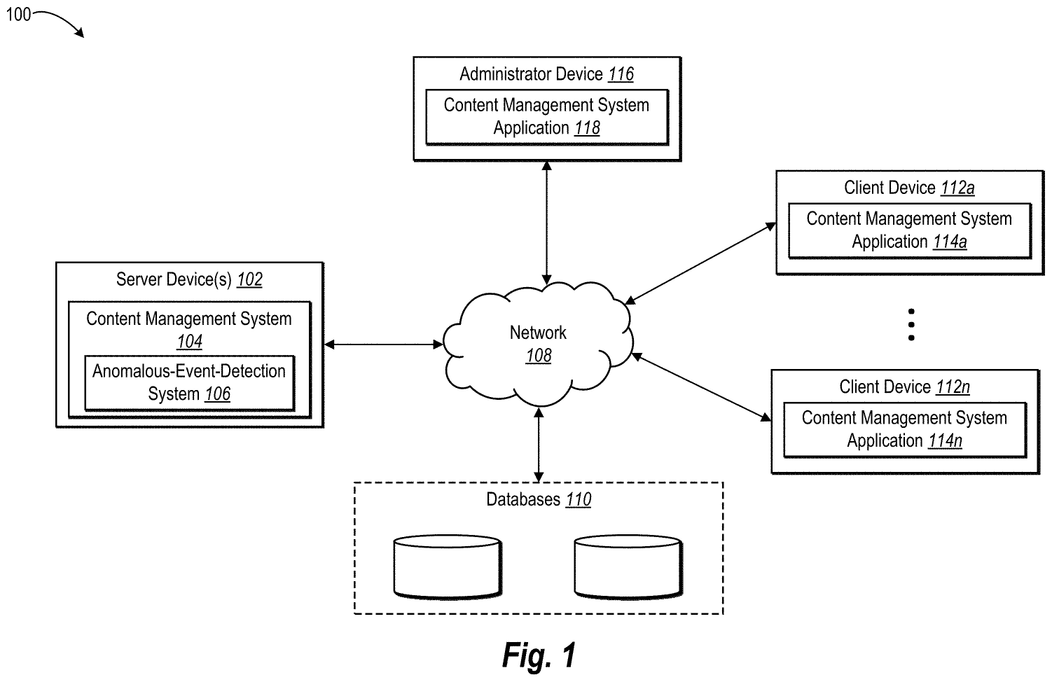

Turning now to the figures, FIG. 1 illustrates a schematic diagram of one implementation of a system 100 (or environment) in which an anomalous-event-detection system operates in accordance with one or more implementations. As illustrated in FIG. 1, the system 100 includes server device(s) 102, a network 108, databases 110, client devices 112a-112n, and an administrator device 116. As further illustrated in FIG. 1, the server device(s) 102, the client devices 112a-112n, and the administrator device 116 communicate via the network 108.

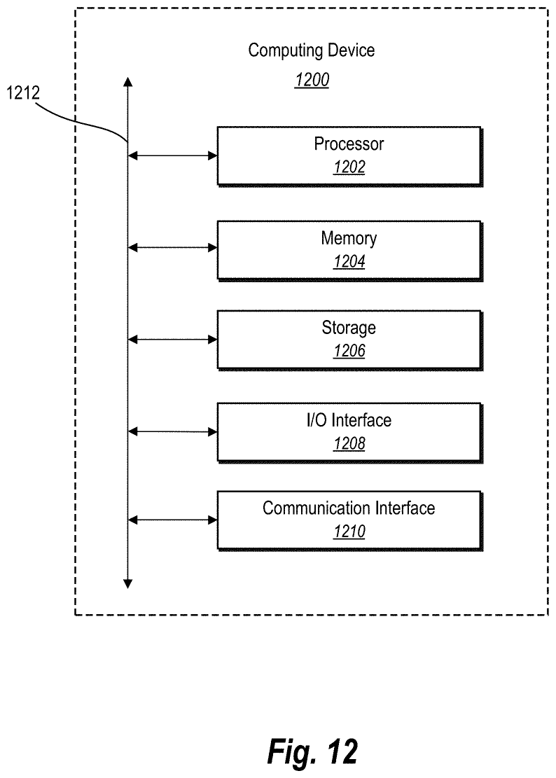

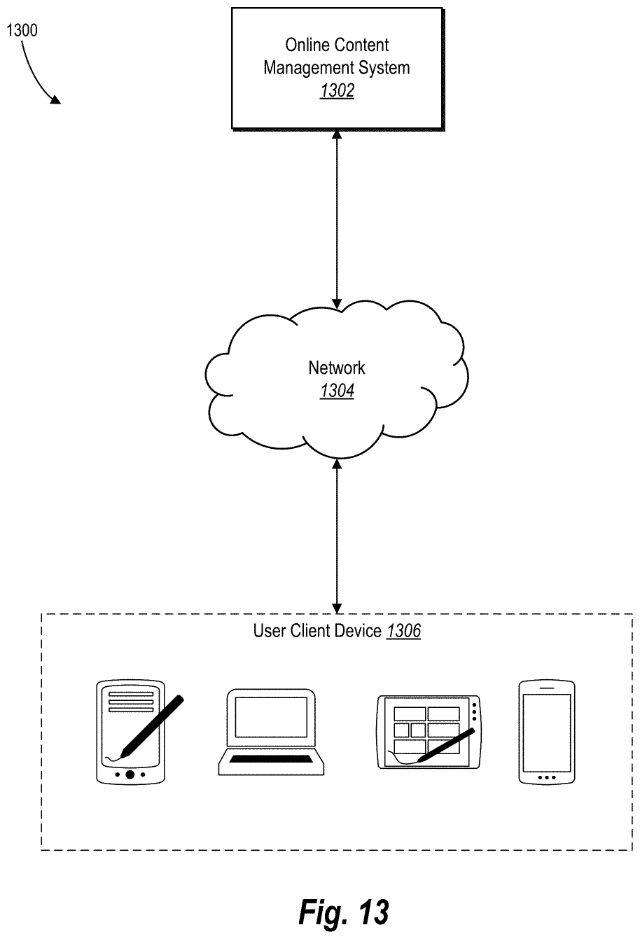

As shown in FIG. 1, the server device(s) 102 includes a content management system 104, which further includes the anomalous-event-detection system 106. In particular, the content management system 104 provides functionality by which a user (not shown in FIG. 1) can use the client device 112a or 112n to generate, manage, and/or store digital content. For example, a user can generate new digital content using the client device 112a. Subsequently, a user utilizes the client device 112a to send the digital content to the content management system 104 hosted on the server device(s) 102 via the network 108. The content management system 104 can then provide many options that a user may utilize to store the digital content, organize the digital content, share the digital content, and subsequently search for, access, view, and/or modify the digital content. Additional detail regarding the content management system 104 is provided below (e.g., in relation to FIG. 13 and the content management system 1302). Furthermore, the server device(s) 102 can include, but are not limited to, a computing (or computer) device (as explained below with reference to FIG. 12).

Additionally, as just mentioned, the server device(s) 102 includes the anomalous-event-detection system 106. In particular, the anomalous-event-detection system 106 can receive digital actions (in association with digital content) from the client devices 112a-112n via the network 108. In addition, the anomalous-event-detection system 106 can utilize various parameters of the digital actions (e.g., obtained from the client devices 112a-112n, the administrator device 116, and/or the databases 110) with an anomaly-detection model to detect anomalous actions. Upon detecting an anomalous action, the anomalous-event-detection system 106 can perform remedial actions for the detected anomalous actions and the digital content associated with those detected anomalous actions. Furthermore, in some embodiments, the anomalous-event-detection system 106 can provide an electronic communication (e.g., an alert, e-mail) to the administrator device 116 to indicate that a digital action was detected as anomalous. Additionally, the anomalous-event-detection can utilize data (e.g., interactions, responses to remedial actions) received from the administrator device 116 to modify the anomaly-detection model (e.g., feedback loop training).

As further shown in FIG. 1, the system 100 includes the client devices 112a-112n. In one or more implementations, the client devices 112a-112n include, but are not limited to, mobile devices (e.g., smartphones, tablets), laptops, desktops, or other types of computing devices, as explained below with reference to FIG. 12. For example, the client devices 112a-112n can be operated by users to perform various functions (e.g., via the content management system applications 114a-114n) such as, but not limited to, creating, receiving, viewing, modifying, and/or transmitting digital content, configuring user account or application settings of the content management system 104, and/or electronically communicating with other user accounts of the content management system 104.

To access the functionalities of the content management system 104 (and the anomalous-event-detection system 106), users can interact with the content management system applications 114a-114n via the client devices 112a-112n. The content management system applications 114a-114n can include one or more software applications installed on the client devices 112a-112n. In some embodiments, the content management system applications 114a-114n are hosted on the server device(s) 102 and are accessed by the client devices 112a-112n through a web browser and/or another online platform. In one or more embodiments, the client devices 112a-112n include various numbers and types of client devices.

As further shown in FIG. 1, the system 100 includes the administrator device 116. The administrator device 116 can include, but is not limited to, a mobile device (e.g., smartphone, tablet), laptop, desktop, or other type of computing device, as explained below with reference to FIG. 12. In one or more embodiments, the administrator device 116 can include various numbers and types of administrator (computing) devices.

In one or more embodiments, the content management system 104 includes or supports a document-synchronizing platform through which the client devices 112a-112n perform digital actions. Indeed, in some cases, the client devices 112a-112n perform such digital actions via the document-synchronizing platform by using the content management system applications 114a-114n. For instance, the client devices 112a-112n can access, edit, or share synchronized documents (and other digital content items) through the document-synchronizing platform. Based on such digital actions from the client devices 112a-112n, the content management system 104 can execute software applications from the document-synchronizing platform to store and synchronize changes to documents (and other digital content items) across multiple user accounts. For example, the content management system 104 can synchronize documents (and other content items) accessible via the content management system applications 114a-114n across various the client devices 112a-112n corresponding to the multiple user accounts and/or database space within the content management system 104.

For instance, the administrator device 116 is operated by an administrator user to perform various functions (e.g., via the content management system application 118) such as, but not limited to, receiving, viewing, and/or interacting with electronic communications for anomalous action alerts (from the anomalous-event-detection system 106). In some embodiments, the administrator device 116 is also operated to receive, view, and/or select selectable options to initiate (or cancel) remedial actions in response to detected anomalous actions and/or configure settings for the content management system 104 and/or the anomalous-event-detection system 106. Additionally, the anomalous-event-detection system 106 can utilize data (e.g., interactions, selections, views) received from the administrator device 116 to modify an anomaly-detection model (e.g., feedback loop training).

Additionally, as shown in FIG. 1, the system 100 includes the databases 110. The databases 110 can include, but are not limited to, server devices, cloud service computing devices, or any other types of computing devices (including those explained below with reference to FIG. 12). In one or more embodiments, the databases 110 can include various stored data of the content management system 104. For example, the databases 110 can include multiple sources of data that manage various aspects (or components) of the content management system 104. In particular, the multiple sources of data can include data such as, but not limited to, user information for users of the content management system 104, stored digital content, digital action event information for action events that occur within the content management system 104. In one or more embodiments, the anomalous-event-detection system 106 utilizes the data from the multiple sources of the databases 110 to generate a knowledge graph that connects the data components utilized by the anomaly-detection model to detect anomalous events.

Although FIG. 1 illustrates the anomalous-event-detection system 106 being implemented by a particular component and/or device within the system 100 (e.g., the server device(s) 102), in some embodiments, the anomalous-event-detection system 106 is implemented, in whole or part, by other computing devices and/or components in the system 100. For example, in some implementations, the anomalous-event-detection system 106 is implemented on the client device 112a (or the administrator device 116) within the content management system application 114a. More specifically, in some embodiments, some or all of the anomalous-event-detection system 106 is implemented by the content management system application 114a.

Additionally, as illustrated in FIG. 1, the system 100 includes the network 108 that enables communication between components of the system 100. In certain implementations, the network 108 includes a suitable network and may communicate using any communication platforms and technologies suitable for transporting data and/or communication signals between the server device(s) 102, the client device(s) 112a-112n, and the administrator device 116. An example of the network 108 is described with reference to FIG. 12. Furthermore, although FIG. 1 illustrates the server device(s) 102 and the client devices 112a-112n communicating via the network 108, in certain implementations, the various components of the system 100 communicate and/or interact via other methods (e.g., the server device(s) 102 and the client devices 112a-112n communicating directly).

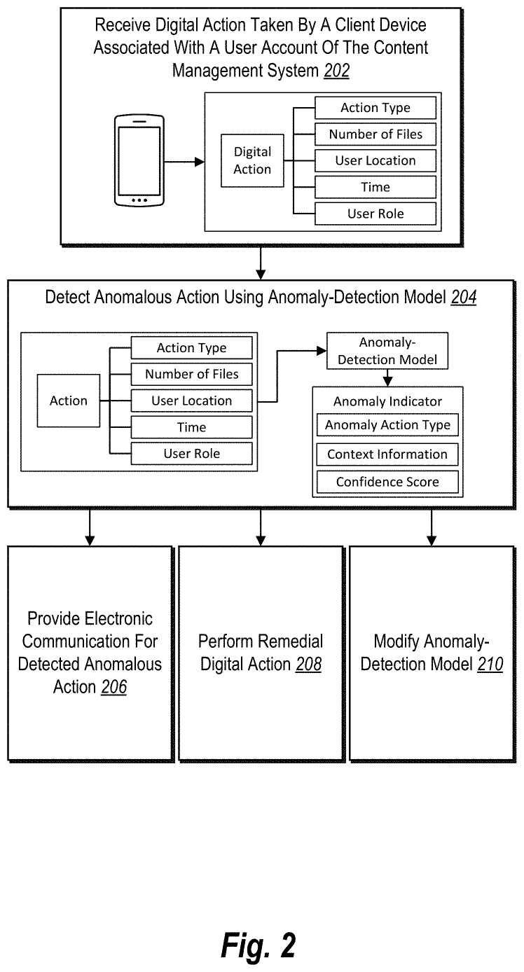

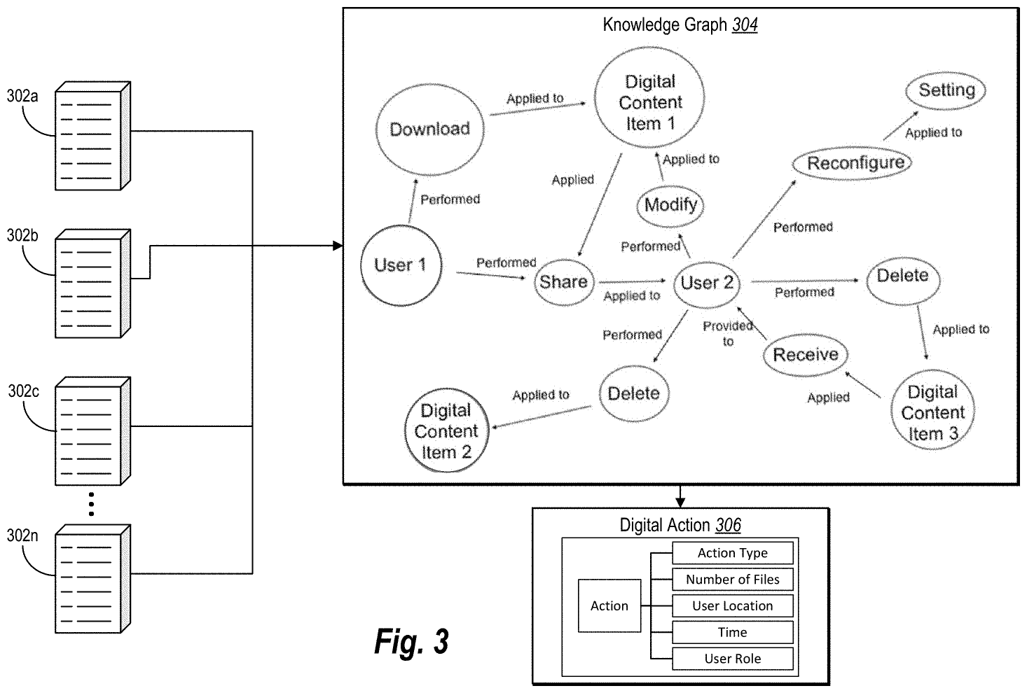

As previously mentioned, the anomalous-event-detection system 106 can utilize a machine-learning model to detect anomalous actions within a content management system. For example, FIG. 2 illustrates an overview of the anomalous-event-detection system 106 detecting anomalous actions utilizing an anomaly-detection model. In particular, as shown in FIG. 2, the anomalous-event-detection system 106 receives, in an act 202, a digital action taken by a client device associated with a user account of the content management system 104. In some cases, the digital action can be identified from a knowledge graph as described below (e.g., in relation to FIG. 3). As also shown in the act 202 of FIG. 2, the anomalous-event-detection system 106 further identifies parameters for the digital action, such as an action type, number of files, user location, time, and user role for the identified digital action (e.g., as described in greater detail below in FIG. 3).

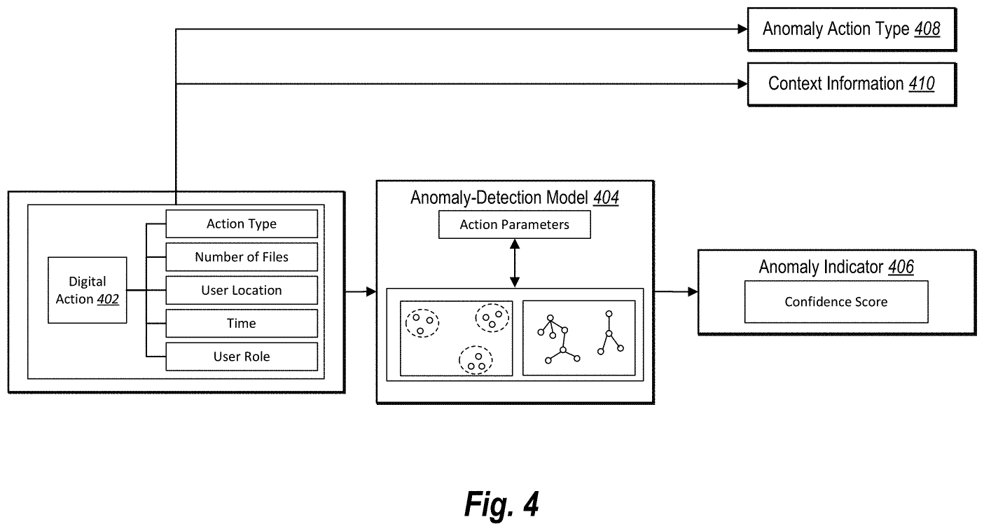

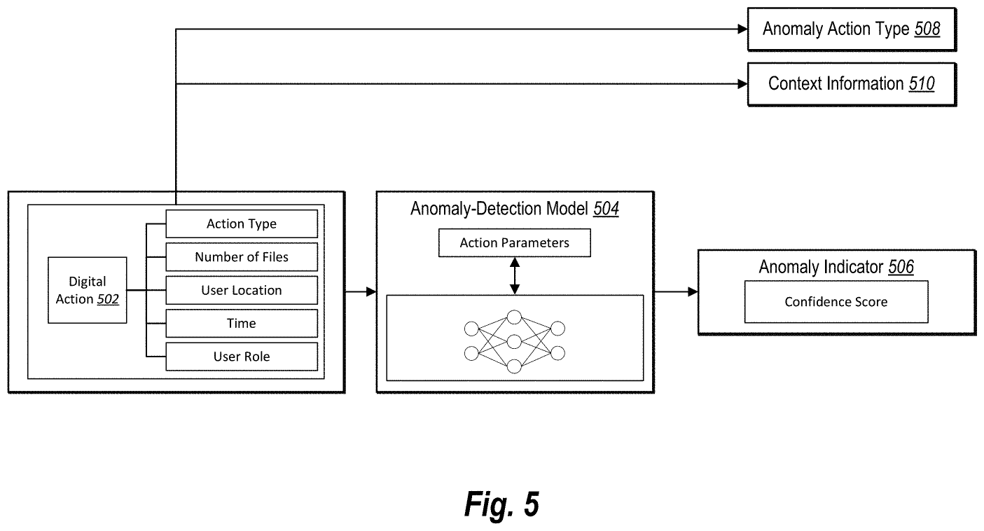

As further shown in act 204 of FIG. 2, the anomalous-event-detection system 106 detects an anomalous action using an anomaly-detection model. In particular, based on parameters of the digital action, the anomalous-event-detection system 106 can utilize the anomaly detection model to generate an anomaly indicator. As shown in FIG. 2, the anomaly indicator includes a confidence score that indicates a likelihood of the digital action being an anomalous action. Furthermore, the anomalous-event-detection system 106 can determine an anomaly action type and context information for the anomalous action based on parameters of the digital action. In describing FIGS. 4 and 5 below, this disclosure describes the anomalous-event-detection system 106 utilizing an anomaly-detection model to generate an anomaly indicator based on parameters of a digital action.

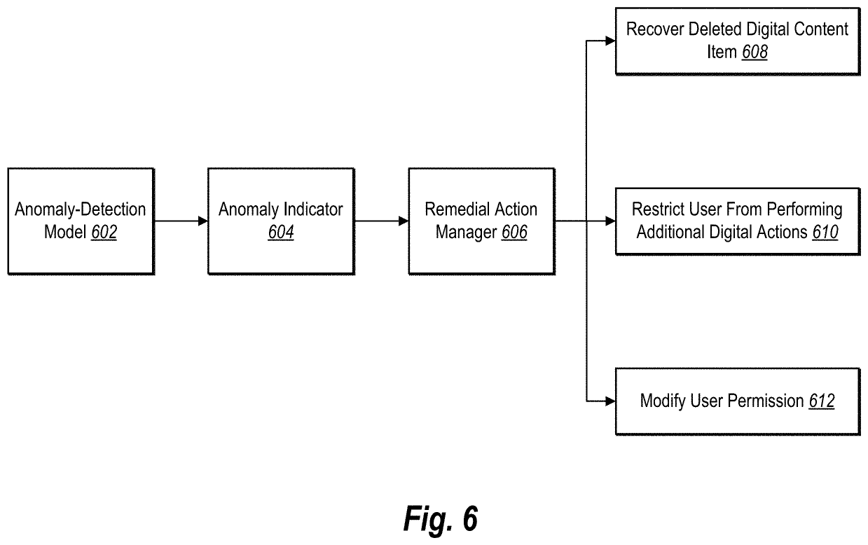

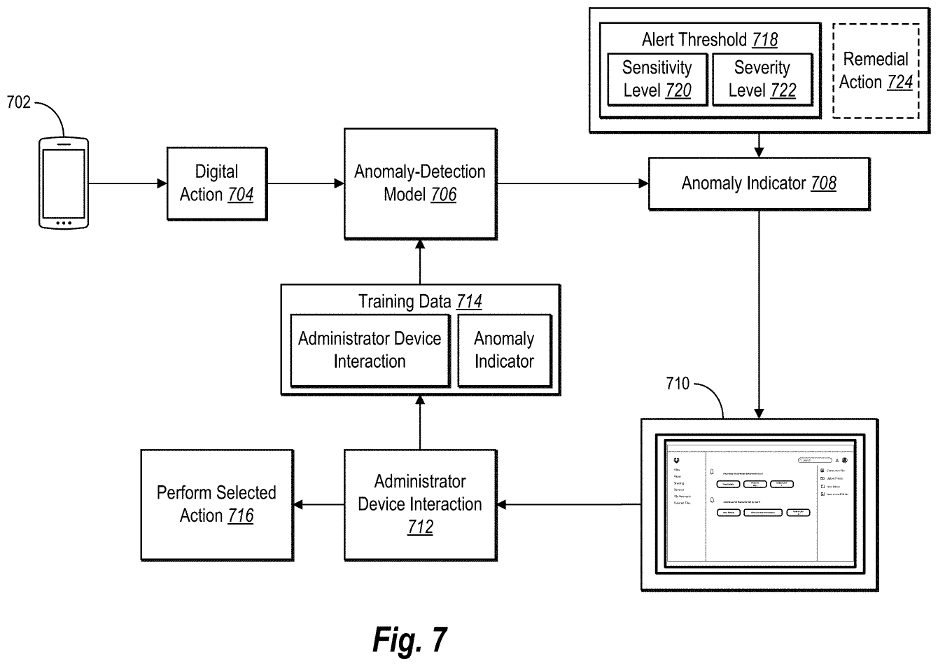

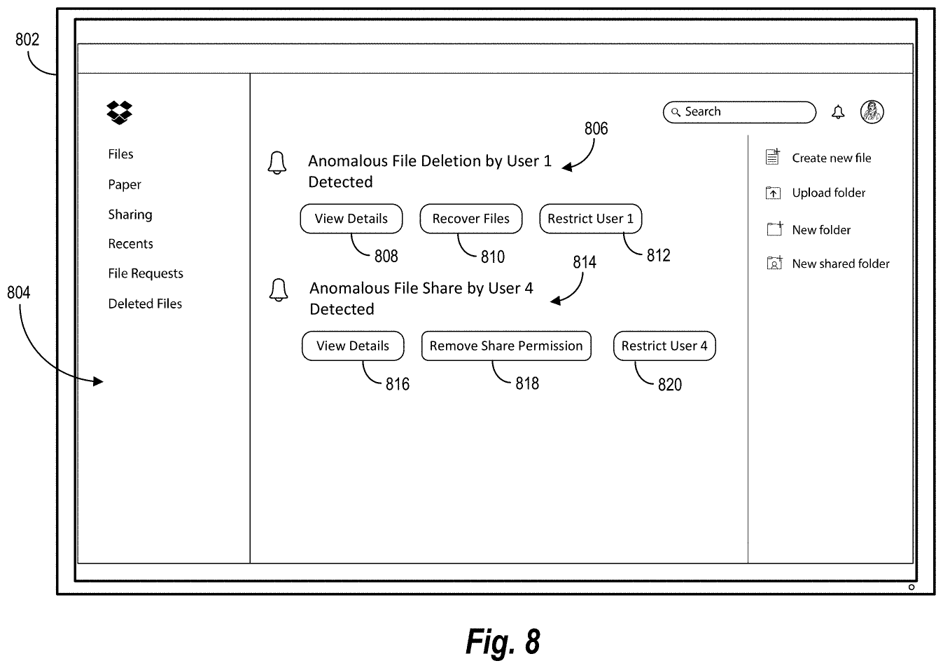

After detecting an anomalous action, as further shown in FIG. 2, the anomalous-event-detection system 106 utilizes the detected anomalous action to perform various tasks. For example, as illustrated in act 206 of FIG. 2, the anomalous-event-detection system 106 can provide an electronic communication for the detected anomalous action to a client device (e.g., as described in greater detail in relation to FIGS. 7 and 8). Moreover, as shown in act 208 of FIG. 2, the anomalous-event-detection system 106 can perform a remedial digital action in response to the detected anomalous action (e.g., as described in greater detail in relation to FIG. 6). In addition, as shown in act 210 of FIG. 2, the anomalous-event-detection system 106 can modify the anomaly-detection model based on the detected anomalous action (e.g., using user interactions with the anomalous action from an administrator device) as described in greater detail below (e.g., in relation to FIG. 7).

As previously mentioned, in some embodiments, the anomalous-event-detection system 106 can monitor digital actions executed across a digital-content-synchronization platform in real (or near-real) time to identify digital actions and other data corresponding to the digital actions. For example, FIG. 3 illustrates the anomalous-event-detection system 106 receiving information from one or more data sources 302a-302n (e.g., databases 110) within an interconnected graph (e.g., a knowledge graph 304) of data corresponding to the content management system 104. Then, as shown in FIG. 3, the anomalous-event-detection system 106 retrieves data and data relationships from the knowledge graph 304 to identify a digital action 306 of interest and parameters corresponding to the digital action 306.

As shown in FIG. 3, the anomalous-event-detection system 106 receives information from the data sources 302a-302n. In one or more embodiments, the data sources 302a-302n include various databases that store and process specific data for various aspects of the content management system 104. To illustrate, the data sources 302a-302n can include one or more data sources for digital content data, user data, user activity data, and/or cyber security data.

Furthermore, the data sources 302a-302n can receive from and/or transmit data to various client devices. For example, the content management system 104 can transmit data representing user interactions and activities of users on client devices to the data sources 302a-302n for storage. In some instances, the data sources 302a-302n also include data received from and/or transmitted to various third-party applications and/or third-party servers. In addition, the data sources 302a-302n can include historical data (e.g., snapshots of data from 30 days, 60 days, 90 days, 120 days, 2 years ago).

As an example, the data sources 302a-302n can include a data source for digital content data. In particular, the anomalous-event-detection system 106 can store and retrieve digital content data (e.g., electronic documents, folders, videos, images) that is created, uploaded, modified, shared, and/or synchronized to the content management system 104 (from client devices of users). In addition, the digital content data can include properties (or metadata) of the digital content (e.g., file size, file type, creation date, modified date, creation source).

Furthermore, the data sources 302a-302n can include a data source for user properties (or characteristics). For example, the anomalous-event-detection system 106 can store and retrieve user data (e.g., names, usernames, personal identifiable information, IP locations, account age) for user accounts of users utilizing and operating on the content management system 104. In one or more embodiments, the anomalous-event-detection system 106 further stores and retrieves user data such as, but not limited to, user account preference settings, user account share settings, user roles, email domains, user engagement data (e.g., the amount of activity of a user on the content management system 104), organization and group associations of the user account, and/or user collaborators corresponding to the user account. In certain instances, the anomalous-event-detection system 106 generates and stores user data embeddings by utilizing a machine learning model to extract features of user data (via a neural network) that represent latent features of a user (e.g., as a feature vector or feature embedding for a neural network).

In addition to user properties, the data sources 302a-302n can include a data source for user activities and activity characteristics. For instance, the user activities and activity characteristics can include data representing a user account session and the devices utilized for the session. In particular, the anomalous-event-detection system 106 can store and retrieve user activities and activity characteristics, such as login activities (e.g., login times, logoff times, login locations, logoff locations), session time, web browser information, operating system information, and/or device information.

Moreover, the data sources 302a-302n can include a data source for events (e.g., digital actions) corresponding to the content management system 104. For example, the anomalous-event-detection system 106 can identify, from the data source, events such as, but not limited to, user interactions with digital content, user interactions with user settings, changes corresponding to digital content, and/or changes corresponding to user settings within the content management system 104. In some embodiments, events include digital actions as described herein. More specifically, the anomalous-event-detection system 106 can include digital actions, such as digital content deletions, digital content modifications, digital content creations, digital content relocations, modifications of a setting and/or preference, and/or transmission of an electronic communication. In addition or in the alternative to identifying such actions or events, the anomalous-event-detection system 106 can also generate and store user-activity-sequence embeddings that represent latent features of the action sequence in which users take digital actions. For example, the anomalous-event-detection system 106 can utilize a machine-learning model to extract features of digital actions taken by users that represent latent features of the action sequence in which users take digital actions and/or other features of the digital action.

In addition to events, the data sources 302a-302n can include a data source for collaborator (or team) data. To illustrate, the collaborator data can include user interactions within a team or group, characteristics of user interactions with a team (e.g., frequency of interactions, frequency of communications, time between interactions), and/or characteristics of a group or team (e.g., size of team, age of team, number of activities) that corresponds to a user. Moreover, the collaborator data can also include devices utilized by user accounts within the content management system 104, locations of user accounts within the collaborative group or team, email domains used by user accounts within the collaborative group or team, applications linked to the collaborative group or team, and/or one or more locations associated with the collaborative group or team.

In certain instances, the data sources 302a-302n can also include a data source for cyber security data. In particular, the cyber security data can include threat intelligence data from a data threat detection system (e.g., a third-party cyber security application, ransomware detection system, and/or a cyber security application of the content management system 104). For example, the cyber security data can include information on known user email addresses and/or other user identifiers that engage in malicious activity, internet service provider reputations, domain reputations, IP address reputations, and/or other reports or data corresponding to cyber security tasks of a particular user email address, user account, and/or other user identifier. In addition, in some embodiments, the cyber security data can also include determinations and/or outputs from abuse rule-based detection and/or mitigation engines that identify malicious behaviors from interactions with web browsers (or applications).

As shown in FIG. 3, in one or more embodiments, the anomalous-event-detection system 106 utilizes a knowledge graph that includes an aggregation of data or interconnected data for users and digital content on the content management system 104. For instance, in reference to FIG. 3, the anomalous-event-detection system 106 can utilize the knowledge graph 304 that is generated from various combinations of the above-mentioned data (e.g., from the data sources 302a-302n). As shown in FIG. 3, in one or more embodiments, the anomalous-event-detection system 106 integrates the above-mentioned data into an interlinked data structure (or graph) that represents relationships between objects, events, and other concepts from the above-mentioned data to generate or update the knowledge graph 304. For simplicity and illustrative purposes, FIG. 3 illustrates merely a portion of the knowledge graph 304. In practice, the knowledge graph 304 can include many more additional nodes and edges.

In some instances, the anomalous-event-detection system 106 can identify activities (at a user level or an organizational level) from the knowledge graph 304. For example, the anomalous-event-detection system 106 can obtain relational contexts between user accounts, digital content, settings, and collaborative groups within the knowledge graph 304 (e.g., by utilizing connections between nodes and edges of the knowledge graph 304). For example, as shown in FIG. 3, the anomalous-event-detection system 106 can utilize the knowledge graph 304 to identify that user 1 downloaded digital content item 1 while user 2 modified the digital content item 1. Although not shown in FIG. 3, the knowledge graph 304 can include edges and nodes indicating private information or security levels. For instance, the knowledge graph 304 can have edge or nodal representations that indicate that another user (e.g., a user 3) was the creator of the digital content item 1 and the digital content item 1 was classified as having PII.

In many instances, the anomalous-event-detection system 106 can identify various aggregate activities (e.g., multiple users modified a digital content item, a user deleted multiple digital content items, a user downloaded multiple digital content items). In one or more embodiments, the anomalous-event-detection system 106 identifies aggregate activities by utilizing multiple nodes and edges of the knowledge graph 304 that represent data of the content management system 104 through multiple data sources as described above (e.g., from the data sources 302a-302n).

In some embodiments, the anomalous-event-detection system 106 embeds the above-mentioned data as data embeddings in the knowledge graph 304. For example, the anomalous-event-detection system 106 can extract (or generate) feature embeddings for various combinations of the digital content data, user data, user activity data, and/or cyber security data (as mentioned above) utilizing a neural network to embed within the knowledge graph 304. Additionally, the anomalous-event-detection system 106 can utilize the feature embeddings to determine relationships and/or connections between the data (e.g., utilizing distance similarities, feature similarities).

In one or more embodiments, the anomalous-event-detection system 106 monitors the knowledge graph 304 as the content management system 104 updates the knowledge graph 304 in real (or near-real) time to identify digital actions and other relational data for the digital actions (e.g., parameters). To illustrate, the anomalous-event-detection system 106 can traverse the knowledge graph 304 to identify a digital action and utilize edges corresponding to the node of the digital action within the knowledge graph to extract one or more parameters of the knowledge graph 304.

As depicted in FIG. 3, for example, the anomalous-event-detection system 106 can identify a digital action node for “delete event” (e.g., indicating a delete digital action) from the knowledge graph 304. Then, the anomalous-event-detection system 106 can traverse the knowledge graph 304 for the digital action node to identify edges and connecting nodes to the digital action node. For instance, as shown in FIG. 3, the digital action node for “delete” is connected to a user 2 node via a “performed” edge and a digital content item 2 node via an “applied to” edge and a digital content item 3 node via an “applied to” edge. Accordingly, the anomalous-event-detection system 106 can identify a digital action that represents a deletion of multiple digital content items (e.g., digital content item 2 and digital content item 3) by a user 2.

As further suggested by FIG. 3, the anomalous-event-detection system 106 can further utilize nodes and edges of the knowledge graph 304 to identify various parameters (e.g., signals) of the digital action. For example, the anomalous-event-detection system 106 can identify parameters corresponding to the digital action and/or the user that initiated the digital action. For instance, the anomalous-event-detection system 106 can identify parameters such as, but not limited to, an action type, a number of files corresponding to the digital action, a user location of the initiating user, a time of the digital action, and/or a user role of the initiating user.

As indicated above, in some embodiments, the anomalous-event-detection system 106 can identify parameters that provide context (or descriptors) for the digital action. For example, the anomalous-event-detection system 106 can identify a digital action type to indicate what type of event occurred (e.g., a deletion, a move, a creation, a modification). In addition, the anomalous-event-detection system 106 can identify a time zone (and/or time) of the digital action. In particular, the anomalous-event-detection system 106 can identify parameters of a digital action that characterize the circumstances of the digital action through information about timing and the type of the digital action. In addition, the anomalous-event-detection system 106 can identify a number of digital content items affected by the digital action as a parameter.

In addition to context for digital actions, in one or more embodiments, the anomalous-event-detection system 106 can also identify parameters that provide context (or descriptors) for a digital content item associated with a digital action. More specifically, the anomalous-event-detection system 106 can identify parameters that describe or characterize the digital content item that is affected by the digital action. For example, the anomalous-event-detection system 106 can identify parameters such as a file size, a file type, file metadata (e.g., creation and last modified date), a number of modifications made to the digital content item, a time of last modification of the digital content item by the user corresponding to the current digital action, collaborator activity (e.g., the number of users within a collaboration and/or group are interacting with the digital content item, the activity times of the number of user), and/or information on the creating user account of the digital content item.

In addition to context for digital content items, in some cases, the anomalous-event-detection system 106 can identify parameters that provide context (or descriptors) for the user that initiated the digital action. For example, the anomalous-event-detection system 106 can identify parameters that describe or characterize the user (or user account) that initiated a current digital action of interest. To illustrate, the anomalous-event-detection system 106 can identify a user engagement metric that measures (or represents) how active the user is on the content management system as a parameter. In some cases, the anomalous-event-detection system 106 can identify user interactivity with digital content items (e.g., the number of files a user interacts with in a given time frame, a frequency of interactions with files, a time distribution of when interactions occur with files) as a parameter.

In addition to the contextual parameters concerning a user just described, the anomalous-event-detection system 106 can also identify parameters that indicate a personal identifiable information (PII) classification for the digital content item to indicate whether the digital content item includes PII information. Additionally, the anomalous-event-detection system 106 can identify parameters that indicate the confidentiality classification for a digital content item by designating the level of confidentiality for the digital content item (e.g., highly confidential, confidential, normal, public).

In addition to PII information, the anomalous-event-detection system 106 can also identify a user role of the user initiating the digital action as a parameter for the digital action. Moreover, in some embodiments, the anomalous-event-detection system 106 also identifies user parameters for the digital action such as, but not limited to, the type of devices the user utilizes (e.g., types of devices and/or operating systems), the email domain utilized by the user, and/or one or more geographic locations associated with the user (e.g., past and present IP address and/or GPS locations). Moreover, the anomalous-event-detection system 106 can identify the amount of activity times of the user at different portions of a day (or week) as a user working hour or user working day parameter.

In addition to parameters for a user role, the anomalous-event-detection system 106 can identify parameters that provide context (or descriptors) for a collaboration (or team) corresponding to the user and/or digital action. In one or more embodiments, the content management system 104 can enable a user account to be associated with one or more other user accounts to form a collaboration (or team) such that multiple user accounts can create, manage, and/or modify a shared number of digital content items (e.g., a shared digital file workspace). The anomalous-event-detection system 106 can identify parameters that describe or characterize collaborations or teams that are associated with the user corresponding to the digital action.

To illustrate, the anomalous-event-detection system 106 can identify activity patterns of the associated teams or collaborations based on an aggregate of activities by user accounts within the team as a parameter. In some embodiments, the anomalous-event-detection system 106 also identifies team parameters for the digital action such as, but not limited to, the common type of devices utilized by a team, the common email domain utilized by the team, and/or one or more common geographic locations associated with the team (e.g., past and present IP address and/or GPS locations). Additionally, in many instances, the anomalous-event-detection system 106 also identifies a user similarity between the user corresponding to the digital action and a team of the user based on various combinations of roles of user accounts within the team, user interactions of the user with other user accounts of the team, and/or based on user interactions of the user with other users that are not associated with the team.

For example, the anomalous-event-detection system 106 can identify a user similarity with a collaborative group or team by clustering the user with various roles of the team (e.g., a cluster of engineers, a cluster of designers, a cluster of HR workers) and determining whether the activities of the user correspond to the role of the user corresponding to the cluster in which the particular user has been grouped. To illustrate, in some embodiments, the anomalous-event-detection system 106 can identify a user similarity by determining whether a user activity corresponds to activities taken by a user in a role of a team or organization corresponding to a determined cluster for the user. Further, in some cases, the anomalous-event-detection system 106 can identify user similarity by determining whether a digital content item accessed (or otherwise interacted with) by a user corresponds to a type of digital content item that is accessed or otherwise interacted with by other users that are clustered with the user. In particular, the anomalous-event-detection system 106 can determine other users to which the user corresponds by utilizing file collaboration edges within the knowledge graph 304 between the users (e.g., a presence of a file collaboration edge indicates that the users have a relation).

In addition to parameters concerning digital actions, users, or collaborators, in some embodiments, the anomalous-event-detection system 106 also identifies cyber security data (as described above) as parameters for a digital action. In particular, the anomalous-event-detection system 106 can utilize threat intelligence data that specifically relates to the user corresponding to the digital action as parameters of the digital action. To illustrate, the anomalous-event-detection system 106 can utilize threat intelligence data as described above (e.g., known malicious activity of a user email address and/or user identifier, internet service provider reputation, domain reputation, IP address reputation, cyber security reports, determinations from abuse rule-based detection engines) as parameters of the digital action.

Although one or more embodiments herein describe utilizing the knowledge graph 304 to identify digital actions and corresponding parameters, the anomalous-event-detection system 106 can identify a digital action and the corresponding parameters by utilizing data directly from one or more data sources (e.g., the data sources 302a-302n). In some embodiments, the anomalous-event-detection system 106 can augment a knowledge graph by further utilizing data directly from one or more data sources (in addition to the knowledge graph). Although one or more embodiments utilize a specific set of parameters for the digital action, the anomalous-event-detection system 106 can utilize various combinations of the parameters described herein.

As previously mentioned, the anomalous-event-detection system 106 can detect anomalous actions using an anomaly-detection model. In particular, the anomalous-event-detection system 106 can input a digital action and parameters of the digital action (as described above) into an anomaly-detection model to generate an anomaly indicator (that indicates the digital action as an anomalous action or normal action). In one or more instances, the anomalous-event-detection system 106 can utilize an unsupervised-anomaly-detection model to generate an anomaly indicator from a digital action (and parameters of the digital action).

For example, FIG. 4 illustrates the anomalous-event-detection system 106 utilizing an unsupervised-anomaly-detection model. As shown in FIG. 4, the anomalous-event-detection system 106 provides parameters corresponding to a digital action 402 (e.g., action type, number of files, user location, time, user role) to the anomaly-detection model 404. Based on the digital action parameters of the digital action 402, the anomalous-event-detection system 106 utilizes the anomaly-detection model 404 to generate an anomaly indicator 406. For example, as illustrated in FIG. 4, the anomaly-detection model 404 can include, but is not limited to, a clustering algorithm and/or a random forest algorithm. In some embodiments, the anomalous-event-detection system 106 can further utilize a support vector machine as an anomaly-detection model.

As just noted and illustrated in FIG. 4, the anomalous-event-detection system 106 uses the anomaly-detection model 404 to generate the anomaly indicator 406. As shown in FIG. 4, the anomaly indicator 406 includes a confidence score that indicates the likelihood (or confidence) of the digital action being an anomalous action (as determined by the anomaly-detection model 404). In addition, as illustrated in FIG. 4, the anomalous-event-detection system 106 also determines an anomaly action type 408 and context information 410 based on parameters of the digital action 402 upon determining that the digital action 402 is an anomalous action based on the anomaly indicator 406.

Based on the confidence score of the anomaly indicator 406, the anomalous-event-detection system 106 can determine whether the digital action 402 is an anomalous action. For example, the anomalous-event-detection system 106 can determine whether the anomaly-detection model 404 identified an anomalous action with a confidence score that satisfies a predefined threshold confidence score. In particular, the threshold confidence score can represent a base confidence level that indicates a strong likelihood that the digital action is an anomalous action.

When implementing an unsupervised-anomaly-detection model as the anomaly-detection model 404, in one or more embodiments, the anomalous-event-detection system 106 can utilize a clustering-based-anomaly-detection model to detect anomalous actions. For example, the anomalous-event-detection system 106 can map or categorize the parameters of digital actions in a data space. Then, the anomalous-event-detection system 106 can utilize a clustering algorithm to partition the digital actions (based on the parameters of the digital actions) into clusters.

To illustrate, in one or more embodiments, the anomalous-event-detection system 106 generates clusters for the digital actions based on the similarities of the digital actions' parameters. In certain instances, the anomalous-event-detection system 106 utilizes distances between data vectors generated from the parameters of digital actions to determine similarities between the digital actions. For example, the anomalous-event-detection system 106 decreases the distance between similar digital actions and increases the distance between dissimilar digital actions within a data space (based on the parameters) to identify clusters.

Then, the anomalous-event-detection system 106 can monitor a knowledge graph, in real (or near-real) time, to identify a digital action and parameters of the digital action. Furthermore, the anomalous-event-detection system 106 can map or categorize the parameters for the digital action in the data space with the clustered digital actions to determine whether the digital action is an outlier in comparison to the existing clusters. Upon determining that the digital action is an outlier, the anomalous-event-detection system 106 can generate an anomaly indicator that indicates the digital action as anomalous.

In some instances, the anomalous-event-detection system 106 can utilize distances between the parameters of the digital action and other clusters within the data space to determine a confidence score. For example, the anomalous-event-detection system 106 can generate a higher confidence score as the distance increases from other clusters of the data space (e.g., indicating a greater outlier digital action).

In addition or in the alternative to the clustering-based-anomaly-detection model just described above, the anomalous-event-detection system 106 can utilize various clustering algorithms to cluster digital actions (based on parameters) and identify anomalous digital actions from the clustered digital actions. In some embodiments, the anomalous-event-detection system 106 utilizes a k-means clustering approach to cluster digital actions (based on parameters) and identify anomalous actions. Furthermore, in some instances, the anomalous-event-detection system 106 utilizes a density-based spatial clustering of applications with noise (DBSCAN) approach to cluster digital actions and identify anomalous actions.

Furthermore, in some embodiments, the anomalous-event-detection system 106 utilizes a random-forest-based-anomaly-detection model to detect anomalous actions. For example, the anomalous-event-detection system 106 can generate a tree structure dataset of digital actions with the parameters (e.g., as attributes) of the digital actions as samples. Then, in one or more embodiments, the anomalous-event-detection system 106 traverses the tree structure by partitioning the tree structure (using randomly selected parameters) until a data sample (e.g., a digital action) is isolated. Moreover, the anomalous-event-detection system 106 can utilize the number of partitions (e.g., splits) that were performed prior to isolating a data sample to determine whether the data sample digital action is anomalous.

To illustrate, the number of partitions (e.g., splits) can be utilized by the anomalous-event-detection system 106 to determine the similarity of a digital action (e.g., a data sample) to other data samples of the tree structure. In one or more embodiments, the anomalous-event-detection system 106 utilizes the length of a path (e.g., the number of splits or partitions) of a tree structure prior to isolating a digital action to determine the similarity of the digital action compared to other digital actions in the tree structure. For example, the anomalous-event-detection system 106 can determine that an isolated digital action is increasingly similar to other digital actions as the number of paths (e.g., splits) increase prior to isolation (e.g., the isolated digital action is an inlier). Additionally, when the number of paths (e.g., splits) are fewer prior to isolation, the anomalous-event-detection system 106 can determine that an isolated digital action is increasingly dissimilar to other digital actions (e.g., the isolated digital action is an outlier and, therefore, anomalous). In particular, the anomalous-event-detection system 106 can identify a lower number of paths to indicate that a digital action is not similar to other digital actions (e.g., an outlier).

To determine an anomalous action utilizing a random-forest-based-anomaly-detection model, the anomalous-event-detection system 106 can utilize a threshold number of partitions. For instance, the anomalous-event-detection system 106 can calculate the number of partitions prior to isolating a sample digital action. Then, the anomalous-event-detection system 106 can compare the number of partitions to the threshold number of partitions. In one or more embodiments, the anomalous-event-detection system 106 can determine that a digital action is an inlier when the number of partitions satisfies the threshold number of partitions (e.g., is equal to or greater than the threshold number of partitions). In one or more embodiments, the anomalous-event-detection system 106 can determine that a digital action is an outlier (e.g., anomalous) when the number of partitions does not satisfy the threshold number of partitions (e.g., is less than the threshold number partitions).

When utilizing a random-forest-based-anomaly-detection model, in one or more embodiments, the anomalous-event-detection system 106 generates an anomaly indicator based on the number of partitions from the tree structure. For example, upon determining that a digital action is an outlier (e.g., anomalous) based on the number of partitions not satisfying the threshold number of partitions, the anomalous-event-detection system 106 can determine a confidence score to utilize for an anomaly indicator for the digital action. For instance, the anomalous-event-detection system 106 can assign or determine a greater confidence score when the number of partitions to isolate a digital action sample is lower (e.g., a lower number of partitions is a strong indicator of an anomalous action). In particular, the anomalous-event-detection system 106 can assign a digital action that is isolated by the anomalous-event-detection system 106 in an isolation tree with two partitions a higher confidence score than a digital action that is isolated with three partitions.

As suggested above, in certain instances, the anomalous-event-detection system 106 can quickly detect an anomalous action with computational efficiency by utilizing a random-forest-based-anomaly-detection model. In particular, the anomalous-event-detection system 106 can detect anomalous actions from newly identified digital actions in real (or near-real) time by computing partitions for the newly identified digital actions for the number of parameters within the tree structure. For example, the anomalous-event-detection system 106 can traverse the height of the tree structure as a linear computational cost.

In addition to the random-forest-based-anomaly-detection model described above, the anomalous-event-detection system 106 can utilize various other random-forest-based algorithms to detect anomalous actions. In some embodiments, the anomalous-event-detection system 106 utilizes an isolation forest algorithm approach to identify anomalous actions. In some cases, the anomalous-event-detection system 106 can utilize an extended isolation forest algorithm to identify anomalous actions. Furthermore, in some cases, the anomalous-event-detection system 106 can utilize a random cut forest algorithm to identify anomalous actions.

In one or more embodiments, the anomalous-event-detection system 106 can also utilize the unsupervised-anomaly-detection models (e.g., the clustering-based-anomaly-detection model, the random-forest-based-anomaly-detection model) to detect a set of digital actions that together represent an anomaly (e.g., as a pattern of anomalous actions). In particular, the anomalous-event-detection system 106 can analyze parameters from multiple digital actions within an unsupervised-anomaly-detection model to determine whether the multiple digital actions (as a grouping) are an outlier set of digital actions (e.g., anomalous). Similarly to the process described above, the anomalous-event-detection system 106 can use the unsupervised-anomaly-detection model to generate an anomaly indicator that includes a confidence score indicating whether the collective group of digital actions are anomalous. By analyzing parameters of multiple digital actions, in one or more embodiments, the anomalous-event-detection system 106 accordingly detects an anomalous pattern of activity.

As further shown in FIG. 4, in some embodiments, the anomalous-event-detection system 106 determines the anomaly action type 408 based on the parameters of the digital action 402. For example, the anomalous-event-detection system 106 can identify the digital action type (e.g., file deletion, file download) and other parameters of the digital action 402 (e.g., a number of digital content items affected, a number of total digital content items available, a file type) to determine the anomaly action type 408 (e.g., an anomalous file deletion, an anomalous file download, an anomalous mass file deletion). Indeed, as mentioned above, the anomalous-event-detection system 106 can determine anomalous actions such as, but not limited to, an anomalous file deletion, an anomalous file share, an anomalous file creation, an anomalous file modification, an anomalous user role modification, or an anomalous file decryption (or encryption).

As further shown in FIG. 4, in addition to the anomaly action type 408, in some embodiments, the anomalous-event-detection system 106 further generates the context information 410 for the anomalous action based on the parameters of the digital action 402. Upon detecting an anomalous action, for example, the anomalous-event-detection system 106 can identify a context template for the anomalous action. For instance, the anomalous-event-detection system 106 can generate a context template that includes input for information that is relevant to an anomalous action type. To illustrate, a context template for an anomalous delete action can include a file name, a file location, a time of action, an acting user, a location of the acting user, a normal activity pattern of the user, and the reason for the detected outlier (e.g., a cluster distance, a number of random forest partitions). Subsequently, the anomalous-event-detection system 106 can reference parameters (e.g., as described above) corresponding to the digital action 402 identified as an anomalous action to identify the context template inputs. By doing so, the anomalous-event-detection system 106 can generate the context information 410 for an anomalous action that provides detail for why the digital action 402 was identified as anomalous.

As previously mentioned, the anomalous-event-detection system 106 can detect anomalous actions using a neural-network-based-anomaly-detection model to generate an anomaly indicator for a digital action based on parameters of the digital action. For instance, FIG. 5 illustrates the anomalous-event-detection system 106 utilizing a neural-network-based-anomaly-detection model. As illustrated in FIG. 5, the anomalous-event-detection system 106 provides the parameters corresponding to a digital action 502 (e.g., action type, number of files, user location, time, user role) to the anomaly-detection model 504. Based on the digital action parameters of the digital action 502, the anomalous-event-detection system 106 can utilize the anomaly-detection model 504 to generate an anomaly indicator 506. For instance, as illustrated in FIG. 5, the anomaly-detection model 504 can include, but is not limited to, a neural network and/or another machine learning model.

As further illustrated in FIG. 5, the anomalous-event-detection system 106 generates the anomaly indicator 506 using the anomaly-detection model 504. As shown in FIG. 5, the anomaly indicator 506 includes a confidence score. In some instances, the anomalous-event-detection system 106 can utilize the confidence score from the anomaly indicator 506 to determine whether the digital action 502 is an anomalous action. As described above, the anomalous-event-detection system 106 can compare the confidence score with a threshold confidence score to determine whether a digital action is an anomalous action. Furthermore, the anomalous-event-detection system 106 can determine an anomalous action type 508 and context information 510 as described above (e.g., in relation to FIG. 4).

As suggested above, in some embodiments, the anomalous-event-detection system 106 utilizes a classification probability from a neural network as a confidence score for an anomaly indicator. For instance, the anomalous-event-detection system 106 can use a neural network to generate a probability score that indicates the likelihood of a digital action (based on its parameters) being classified as a particular anomalous action. In certain implementations, the anomalous-event-detection system 106 can utilize the probability score as the confidence score of the anomaly indicator.

For instance, in one or more implementations, the anomalous-event-detection system 106 can utilize a neural network that analyzes parameters of a digital action (e.g., type of digital action, number of affected files, a file size, a user location, a time of the digital action, collaborator data, or a user role) to predict the probability of the digital action being an anomalous digital action. In certain instances, the anomalous-event-detection system 106 utilizes neural-network-based-anomaly-detection models that are trained to detect outlier digital actions (e.g., anomalous digital actions) from normal instances of digital actions. For example, the anomalous-event-detection system 106 can utilize a neural network to generate an anomaly indicator that includes a probability of the digital action being anomalous (e.g., confidence score).

As indicated above, the anomalous-event-detection system 106 can utilize various neural-network-based-anomaly-detection models to detect anomalous digital actions based on particular parameters of a digital action. In some embodiments, the anomalous-event-detection system 106 applies autoencoders (unsupervised deep anomaly detection models) to parameters of the digital action (e.g., type of digital action, number of affected files, a file size, a user location, a time of the digital action, collaborator data, or a user role) to detect anomalous actions. In one or more embodiments, the anomalous-event-detection system 106 utilizes Markov Chains as the neural-network-based-anomaly-detection models to detect anomalous actions based on input parameters of a relevant digital action. Additionally, the anomalous-event-detection system 106 can also utilize a restricted Boltzmann machine, a deep Boltzmann machine, a deep belief network, a generalized de-noising Autoencoder, a recurrent neural network, or a long short-term memory (LSTM) neural network as a neural-network-based-anomaly-detection model to detect anomalous digital actions based on particular parameters of digital actions.

As further indicated above, in one or more embodiments, the anomalous-event-detection system 106 utilizes a neural-network-based-anomaly-detection model trained to analyze parameters of multiple digital actions to determine whether the multiple digital actions (as a group) are anomalous. For example, the anomalous-event-detection system 106 can input parameters from multiple digital actions to a neural-network-based-anomaly-detection model to generate an anomaly indicator that includes a confidence score indicating whether the collective group of digital actions are anomalous. In particular, the anomalous-event-detection system 106 can detect an anomalous pattern of activity by analyzing parameters of multiple digital actions with the neural-network-based-anomaly-detection model.

As suggested above, the anomalous-event-detection system 106 can utilize one or more implementations of the above-mentioned anomaly-detection model from FIG. 4 or FIG. 5 to detect a variety of anomalous actions. As an example, the anomalous-event-detection system 106 can detect anomalous actions such as, but not limited to, an anomalous file deletion, an anomalous file share, an anomalous file creation, an anomalous file modification, an anomalous user role modification, or an anomalous file decryption.

To illustrate, the anomalous-event-detection system 106 can identify a file deletion action (as a digital action) and corresponding parameters from a knowledge graph (as described above). Furthermore, the anomalous-event-detection system 106 can analyze the file deletion action using an anomaly-detection model (as described above) to generate an anomaly indicator. The anomaly indicator can include a confidence score that indicates the file deletion as anomalous (e.g., an outlier action). Then, the anomalous-event-detection system 106 can identify the file deletion action as anomalous (e.g., a malicious action to delete files and/or an accidental delete action).

In addition to identifying that a file deletion action is anomalous, the anomalous-event-detection system 106 can also utilize an anomaly-detection model to identify an anomalous action based on parameters specific to the type of digital action of interest. For example, the anomalous-event-detection system 106 can utilize the anomaly-detection model to predict (or determine) that the file deletion is anomalous due to the size of the files being deleted, due to the number of files being deleted, due to the time of deletion (e.g., a time of day in which there is less activity by the particular user). In certain instances, the anomalous-event-detection system 106 can utilize the anomaly-detection model to predict (or determine) that the file deletion is anomalous due to the file(s) being deleted from a user account from a geographic location that does not interact with those file(s), from a user account that does not normally interact with those file(s), and/or from a user account that is associated with a role that does not access or delete files. Moreover, in some embodiments, the anomalous-event-detection system 106 analyzes multiple digital actions utilizing an anomaly-detection model to identify an anomalous mass deletion of files. In some cases, the anomalous-event-detection system 106 can utilize the predicted type of anomalous action to generate a context for the detected anomalous action.

Additionally, the anomalous-event-detection system 106 can also identify other outlier digital actions (as anomalous) by analyzing the particular digital actions with an anomaly-detection model in accordance with one or more embodiments. For instance, the anomalous-event-detection system 106 can analyze a file share action (and corresponding parameters) using the anomaly-detection model to determine whether the file share action is anomalous (e.g., sharing a file with an abnormal email domain). Likewise, the anomalous-event-detection system 106 can utilize an anomaly-detection model (in accordance with one or more embodiments) to detect anomalous file creations, anomalous file modifications (e.g., edits, file name changes, file type changes), and/or anomalous file encryptions or decryptions.

For example, the anomalous-event-detection system 106 can utilize an anomaly-detection model in accordance with one or more embodiments to detect that a user is experiencing a ransomware infection on a client device. In particular, the anomalous-event-detection system 106 can detect multiple modifications (e.g., encryptions) on synchronized digital content items as anomalous and determine that the user is experiencing a ransomware attack. The anomalous-event-detection system 106 can further perform remedial actions to prevent the spread of the ransomware infection (e.g., block synchronization and restore files) and transmit alerts to an administrator device for the anomalous actions (e.g., due to the ransomware).

In addition, the anomalous-event-detection system 106 can also utilize an anomaly-detection model to detect ransomware based on a sequence of data or digital actions on a server (or back-end system) indicative of ransomware. For instance, the anomalous-event-detection system 106 can detect a ransomware infection from a sequence of digital actions is initiated on one or more servers of the content management system 104, where the encrypted or otherwise modified files correspond to a particular client device (e.g., of a user account) that communicates with the servers. Upon detecting from the server-side an anomalous action that indicates a ransomware infection, the anomalous-event-detection system 106 can automatically perform a remedial action, such as blocking the digital actions corresponding to the ransomware infection (e.g., until an administrator device approves of the digital actions), blocking synchronization from a device at which the detected ransomware infection initiated, creating backup versions of the files corresponding to the digital actions that are detected as ransomware, and/or restoring files corresponding to the ransomware infection.

As an example, the anomalous-event-detection system 106 can, from the content management system 104 (e.g., a server-side application), identify a sequence of digital actions initiated by a client device (e.g., third-party client device that has not previously interacted with digital content for a user account/team folder or the content management system 104). Such a sequence of digital actions may include, but is not limited to, spikes or abnormal increases in file modifications, file deletions, or file transfers above a threshold number of such actions for a user account or a team.

From an identified action sequence, the anomalous-event-detection system 106 can input parameters of digital actions executed by one or both of server(s) and client device(s) (e.g., digital action types, file types, number of affected files, file sizes, user location, times of digital actions, collaborator data, user role) into an anomaly-detection model to generate an anomaly indicator for the sequence of digital actions. Based on the input parameters, the anomalous-event-detection system 106 can use the anomaly-detection model to generate an anomaly indicator that the sequence of digital actions is anomalous (e.g., as a ransomware infection). As an example, the sequence of digital actions on a server can indicate client-side ransomware activity, including, but not limited to, a sequence of overwrites of files with encrypted data, moving files to discrete locations followed by encryption and moving files back to an original location, writing encrypted content of a file and deletion of original files, modifications of file extensions, modifications of file names, and/or random modifications of file content.

In accordance with some embodiments, the anomalous-event-detection system 106 can utilize an anomaly-detection model to detect ransomware infections from server-side actions and remedy such infections in various settings. In particular, a ransomware infection can affect single client devices followed by synchronization across the content management system 104 and other client devices, can affect shared folders of a user account corresponding to a client device that has a ransomware infection, and/or can affect multiple server devices and multiple user accounts having data on the multiple server devices. In addition, a ransomware infection can spread to other client devices (or server space) of user accounts after initiating on a single client device via synchronization and/or shared folders on the content management system 104.

By utilizing the anomaly-detection model to detect a ransomware infection based on digital-action sequences observed on one or more server(s), the anomalous-event-detection system 106 can perform remedial actions that prevent (or minimize) the damage to data caused by ransomware infections in the various above-mentioned scenarios. For example, by automatically disabling synchronization from a client device, the anomalous-event-detection system 106 can limit a ransomware infection to the single client device. In addition, the anomalous-event-detection system 106 can disable share access on shared folders to prevent the spread of a ransomware infection from one client device to other client devices. Moreover, the anomalous-event-detection system 106 can prevent communication between server devices (and/or client devices) to limit the effect of a ransomware infection on multiple server devices and/or client devices.

In addition to remedial actions, in one or more embodiments, the anomalous-event-detection system 106 provides, for display on a graphical user interface of an administrator device, an electronic communication indicating ransomware based on a sequence of server-side digital actions. In some cases, the anomalous-event-detection system 106 provides selectable options to the administrator device to cancel (or terminate) the remedial actions taken against the sequence of digital actions or against inferred actions on a client device. Furthermore, the anomalous-event-detection system 106 can provide selectable options to the administrator device that, upon selection, cause the anomalous-event-detection system 106 to perform additional remedial actions in response to the detected ransomware (e.g., restore affected files, delete modified files).

In some embodiments, the anomalous-event-detection system 106 can utilize an anomaly-detection model to detect anomalous file activity by a user within the content management system 104. For example, the anomalous-event-detection system 106 can detect anomalous activities such as, but not limited to, digital content downloads from a geographic location that is uncommon to the user account (or an organization corresponding to the user account), digital content copying into sources outside of the content management system 104, anomalous user logins (e.g., logins from multiple IP addresses in a short period of time, a login from a geographic location that is uncommon for the user account), and/or a user account sharing sensitive PII files with an email domain that is uncommon to an organization associated with the user account.

Additionally, the anomalous-event-detection system 106 can also utilize an anomaly-detection model to analyze parameters of digital actions over a span of time to detect a pattern of anomalous activity (e.g., a mass anomalous deletion, download, sharing over a span of time). For example, the anomalous-event-detection system 106 can analyze parameters of various deletions, downloads, sharing, or other digital actions with an anomaly-detection model to determine that the series of digital actions is anomalous. Furthermore, the anomalous-event-detection system 106 can log the series of digital actions as anomalous.

Upon logging the digital action as anomalous, the anomalous-event-detection system 106, at a future time, can analyze parameters of an additional digital action with the anomaly-detection model to determine that the additional digital action is also anomalous. The anomalous-event-detection system 106 can continue to detect and log anomalous actions for various numbers of subsequent digital actions. Then, in one or more embodiments, the anomalous-event-detection system 106 can identify that the numerous logged anomalous actions indicate an anomalous pattern (e.g., sharing sensitive files periodically) and/or a mass anomalous action (e.g., a mass sharing of files in one time period). Upon identifying the anomalous pattern and/or mass anomalous action, the anomalous-event-detection system 106 can perform a remedial action and/or transmit an anomalous action alert to an administrator device (as described herein) notifying an administrator of the mass anomalous action and/or mass anomalous pattern of activity. Indeed, the anomalous-event-detection system 106 can utilize a log of detected anomalous actions to identify mass anomalous actions such as, but not limited to, mass anomalous digital content deletions, downloads, shares, modifications, and/or creations.

Moreover, in some instances, the anomalous-event-detection system 106 can also utilize an anomaly-detection model to detect anomalous actions corresponding to user settings within the content management system 104. In particular, the anomalous-event-detection system 106 can analyze user setting modifications with an anomaly-detection model (in accordance with one or more embodiments) to detect outlier user setting modifications (as anomalous). For example, the anomalous-event-detection system 106 can analyze a user role modification (and corresponding parameters) using the anomaly-detection model to determine whether the user role modification is anomalous (e.g., an anomalous escalation of a user role). In certain instances, the anomalous-event-detection system 106 can also analyze other user setting modifications, such as, but not limited to, an email address modification, a password modification, a 2-step authentication modification, and/or a file sharing preference modification.

Although not depicted in FIG. 4 or 5, in addition or in the alternative to machine-learning models, in some embodiments, the anomalous-event-detection system 106 utilizes a heuristic-based-anomaly-detection model to detect anomalous actions from digital actions. For example, the anomalous-event-detection system 106 can utilize heuristic-based statistical operations to determine whether a digital action is an anomalous action. In particular, the anomalous-event-detection system 106 can compare parameters corresponding to a digital action (e.g., a number of digital content items affected by a digital action and/or a size of the files affected by the digital action) to a statistical model of historical digital actions to determine whether the digital action is anomalous (e.g., an outlier action). In some cases, the anomalous-event-detection system 106 can utilize an output of a heuristic-based-anomaly-detection model as input for a machine-learning model to detect anomalous actions from digital actions.

In some embodiments, the anomalous-event-detection system 106 utilizes a median absolute deviation method for the heuristic-based-anomaly-detection model that utilizes a median of the absolute deviation from an historical median to identify anomalous actions. In particular, the anomalous-event-detection system 106 can determine a historical median and a median of outliers by utilizing historical digital actions from a knowledge graph. For example, the anomalous-event-detection system 106 can sample historical digital actions and the number of digital content items affected by the digital actions from a knowledge graph. Then, the anomalous-event-detection system 106 can determine a historical median number of digital content items affected by the historical digital actions.

To calculate the median absolute deviation (MAD), the anomalous-event-detection system 106 can calculate the difference between each historical value and an outlier median. Furthermore, the anomalous-event-detection system 106 can express the differences as absolute values and calculate a median that is multiplied by an empirically derived constant to yield the median absolute deviation (MAD). For example, for a historical media Xᵢ and an outlier median Xⱼ, the MAD can be calculated utilizing the following function:

MAD=medianᵢ(|Xᵢ−medianⱼXⱼ|)

For a newly identified digital action, the anomalous-event-detection system 106 can identify a value that corresponds to a number of digital content items affected by the newly identified digital action. Then, the anomalous-event-detection system 106 can compare the anomalous-event-detection system 106 to the MAD to determine whether the newly identified digital action is anomalous. For example, in one or more embodiments, the anomalous-event-detection system 106 can determine that the newly identified digital action is anomalous if the value of the newly identified digital action satisfies a multiplied MAD threshold (e.g., 3 MAD threshold, 4 MAD threshold). In one or more embodiments, the anomalous-event-detection system can select (and/or determine) a MAD threshold based on a sensitivity level determined by an administrator device and/or based on data indicating learned administrator selections to resolve an anomalous digital action in response to similar alerts. Indeed, upon satisfying the MAD threshold, the anomalous-event-detection system 106 can determine that the newly identified digital action affected a number of files that is outside the median absolute deviation and, therefore, an anomalous action. Although one or more embodiments describe utilizing an MAD with a number of digital content items, the anomalous-event-detection system 106 can utilize an MAD with various parameters of a digital action such as, but not limited to, a file size of a digital content item, a number of digital actions, and/or a time of a digital action.

In some embodiments, the anomalous-event-detection system 106 utilizes a median and interquartile deviation method (IQD) for the heuristic-based-anomaly-detection model. In particular, the anomalous-event-detection system 106 can further calculate a 25^{th} percentile and a 75^{th} percentile of the residuals (between historical and outlier medians from digital actions in the knowledge graph). Then, the anomalous-event-detection system 106 can utilize the difference between the 25^{th} percentile and the 75^{th} percentile as the interquartile deviation (IQD). Upon receiving a newly identified digital action, the anomalous-event-detection system 106 can compare the value of the newly identified digital action to the IQD to determine whether the newly identified digital action is anomalous. For example, in one or more embodiments, the anomalous-event-detection system 106 can determine that the newly identified digital action is anomalous if the value of the newly identified digital action satisfies a multiplied IQD threshold (e.g., 2.22 IQD, 2.44 IQD).

In addition, the anomalous-event-detection system 106 can also utilize the heuristic-based-anomaly-detection model for detecting ransomware infections (e.g., on a client device and/or across one or more server devices) based on digital actions on one or more server(s). For example, the anomalous-event-detection system 106 can identify a sequence of digital actions on one or both of server devices and client devices. Then, the anomalous-event-detection system 106 can determine whether the number or size of the sequence of digital actions satisfies a MAD threshold and/or an IQD threshold to indicate an anomalous spike in activity on one or both of server devices and client devices.

To determine the anomalous spike of activity, in some cases, the anomalous-event-detection system 106 can determine whether the amount of activity from the sequence of digital actions is greater than a total number of files corresponding to a user account (e.g., in the user account's namespace, shared folders) and/or is greater than a total number of files corresponding to a team (or organization) associated with the user account. To determine whether the sequence of digital actions is a deviation or spike for the user account (or a team corresponding to the user account), the anomalous-event-detection system 106 can also identify hourly and/or daily activity aggregates from a user account or multiple user accounts within a team to generate a baseline number of file activity. The anomalous-event-detection system 106 can further compare the bassline number of file activity to an amount of activity represented by the sequence of digital actions. Upon determining that the sequence of digital actions constitutes a deviation or spike in activity based on the MAD thresholds, IQD thresholds, number of files, and/or baseline number of file activities, the anomalous-event-detection system 106 can determine that the sequence of digital actions indicate ransomware or other anomalous activity.

As previously mentioned, the anomalous-event-detection system 106 can perform a remedial action in response to a detected anomalous action. For example, FIG. 6 illustrates the anomalous-event-detection system 106 performing remedial actions in response to an anomaly indicator generated by an anomaly-detection model. In particular, as shown in FIG. 6, the anomalous-event-detection system 106 can receive an anomaly indicator 604 from an anomaly-detection model 602 (in accordance with one or more embodiments) that indicates a digital action as anomalous based on a confidence score.

Moreover, as shown in FIG. 6, the anomalous-event-detection system 106 can utilize the anomaly indicator 604 with a remedial action manager 606 to determine a remedial action to perform in response to a detected anomalous action as represented by the anomaly indicator 604. In particular, the anomalous-event-detection system 106 can utilize the remedial action manager 606 to select a remedial action to perform based on the detected anomalous action. For instance, as shown in FIG. 6, based on the anomalous action type in the anomaly indicator 604, the anomalous-event-detection system 106 can recover a deleted digital content item in an act 608, restrict a user account from performing additional digital actions in an act 610, and/or modify user permissions in an act 612.

To illustrate, in one or more embodiments, the anomalous-event-detection system 106 recovers a deleted digital content item in response to detecting an anomalous deletion action (e.g., as shown in the act 608). More specifically, the anomalous-event-detection system 106 can identify one or more digital content items that correspond to a digital deletion action that was detected as anomalous. Then, the anomalous-event-detection system 106 can restore the one or more deleted digital content items on the content management system 104. In some cases, the anomalous-event-detection system 106 can prevent the anomalous deletion of a digital content item by preventing the delete action prior to executing the delete action on the content management system 104.

In addition to recovering deleted digital content items, in one or more embodiments, the anomalous-event-detection system 106 can recover a digital content item in response to a detected anomalous modification of a digital content item. In particular, the anomalous-event-detection system 106 can identify one or more digital content items that correspond to a detected anomalous modification of digital content. Subsequently, the anomalous-event-detection system 106 can recover or restore previous versions of the one or more digital content items to reverse the anomalous modifications detected by an anomaly-detection model. Additionally, the anomalous-event-detection system 106 can prevent the modification action prior to execution upon detecting that the modification action is anomalous (in accordance with one or more embodiments).

Beyond recovering modified digital content items, the anomalous-event-detection system 106 can restrict a user from performing additional digital actions in response to detecting an anomalous action (e.g., as shown in the act 610). For example, the anomalous-event-detection system 106 can identify the user account that initiated the detected anomalous action (e.g., via the parameters of the digital action). Then, the anomalous-event-detection system 106 can restrict the identified user account from performing additional digital actions on the content management system 104. By doing so, the anomalous-event-detection system 106 can prevent any additional anomalous actions (e.g., malicious and/or accidental) from the same user account.

Independently of restricting user actions, the anomalous-event-detection system 106 can also modify user permissions in response to detecting an anomalous action (e.g., as shown in the act 612). More specifically, the anomalous-event-detection system 106 can revert user setting modifications to previous settings upon detecting outlier user setting modifications (as anomalous). For example, the anomalous-event-detection system 106 can detect that an anomalous user role modification has occurred on the content management system 104. Subsequently, the anomalous-event-detection system 106 can revert the user role modification by changing the user role to the previously configured role.

As indicated above, in certain instances, the anomalous-event-detection system 106 can also provide, for display on a graphical user interface of an administrator device, an electronic communication indicating the detection of the anomalous action and the performance of the remedial action. Moreover, in some embodiments, the anomalous-event-detection system 106 also provides, for display on the graphical user interface of the administrator device, one or more selectable options to cancel (or terminate) a remedial action. In particular, upon receiving an indication of a user interaction with the selectable option to cancel, the anomalous-event-detection system 106 can terminate the remedial action and revert the digital content (or user settings) to its state prior to the remedial action.

As previously mentioned, the anomalous-event-detection system 106 can modify an anomaly-detection model based on data received from an administrator device upon detection of an anomalous action. For example, FIG. 7 illustrates the anomalous-event-detection system 106 utilizing data received from an administrator device—after detection of an anomalous action—as training data to modify an anomaly-detection model. As an overview of FIG. 7, the anomalous-event-detection system 106 utilizes an anomaly-detection model 706 to generate an anomaly indicator 708 based on parameters of a digital action 704. Then, the anomalous-event-detection system 106 provides an anomalous action alert (via an electronic communication) to an administrator device 710 and receives an administrator device interaction 712 indicating a response to the anomalous action. The anomalous-event-detection system 106 utilizes the administrator device interaction 712 (e.g., a selection to perform a remedial action, a confirmation of the anomalous action, or an affirmative rejection of the anomalous action alert) as training data to train the anomaly-detection model 706.

As shown in FIG. 7, the anomalous-event-detection system 106 identifies the digital action 704 performed by a client device 702. Then, the anomalous-event-detection system 106 analyzes the digital action 704 with the anomaly-detection model 706 to generate the anomaly indicator 708 (in accordance with one or more embodiments). Based on the anomaly indicator 708, the anomalous-event-detection system 106 can perform the following actions that gather training data from the administrator device 710.

In one or more embodiments, the anomalous-event-detection system 106 provides, for display on a graphical user interface of the administrator device 710, an electronic communication that indicates the digital action 704 as an anomalous action (based on the generated anomaly indicator 708). Subsequently, the anomalous-event-detection system 106 receives data indicating the administrator device interaction 712 with the electronic communication indicating the digital action 704 as anomalous as training data 714. For instance, the anomalous-event-detection system 106 can utilize the training data 714 (which includes the administrator device interaction and the anomaly indicator) to modify the anomaly-detection model 706. In addition, the anomalous-event-detection system 106 can also perform a selected action 716 as indicated within the administrator device interaction 712 (e.g., a selection of a remedial action).

As examples of an administrator device interaction to a detected anomalous action, in one or more embodiments, the anomalous-event-detection system 106 receives an indication of a selection of a remedial action, a cancellation of a remedial action, and/or no selection of an action. In certain instances, the administrator device interaction can include a rejection of the anomalous action (e.g., indicating that the action that was determined by the anomalous-event-detection system 106 to be anomalous was in fact not anomalous). The anomalous-event-detection system 106 can utilize such interactions with the anomaly indicator as ground truth data to modify (or adjust) the anomaly-detection model.

To illustrate, the anomalous-event-detection system 106 can label an anomaly indicator based on the administrator device interaction as a true positive, false positive, or a benign true positive. For instance, the anomalous-event-detection system 106 can label the anomaly indicator as a true positive when the administrator device interaction triggers an affirmative response (e.g., a remedial action) directed to the detected anomalous action. Furthermore, the anomalous-event-detection system 106 can label the anomaly indicator as a false positive when the administrator device interaction does not react to the detected anomalous action, provides no remedial action selection for the anomalous action, or affirmatively indicates that the detected anomalous action is not anomalous. Additionally, the anomalous-event-detection system 106 can label the anomaly indicator as a benign true positive when the administrator device interaction indicates that the digital action is anomalous but does not take further remedial action to react to the anomalous action (e.g., the anomalous action is not malicious and does not need to be reversed or otherwise remedied).

Based on the detected administrator device interaction to the anomaly indicator, for example, the anomalous-event-detection system 106 can adjust parameters of a neural-network-based-anomaly-detection model. For instance, the anomalous-event-detection system 106 can reinforce the predicted anomalous action within the neural-network-based-anomaly-detection model when the administrator device interaction to the anomaly indicator treats the anomalous action as a true positive anomalous action. Moreover, the anomalous-event-detection system 106 can deemphasize the predicted anomalous action within the neural-network-based-anomaly-detection model when the administrator device interaction to the anomaly indicator treats the anomalous action as a false positive anomalous action. In some embodiments, the anomalous-event-detection system 106 can backpropagate a loss calculated from the administrator device interaction and the anomaly indicator to the neural-network-based-anomaly-detection model to modify the anomaly-detection model.

In the alternative to adjusting parameters of a neural-network-based-anomaly-detection model, in some embodiments, the anomalous-event-detection system 106 modifies a clustering-based-anomaly-detection model and/or a random-forest-based-anomaly-detection model based on an administrator device interaction to an anomaly indicator. For instance, the anomalous-event-detection system 106 can modify distance values utilized between digital action data points within a clustered data space for a clustering-based-anomaly-detection model based on administrator device interactions to anomaly indicators. Moreover, the anomalous-event-detection system 106 can also modify a threshold number of partitions representing an anomalous action within a random-forest-based-anomaly-detection model based on administrator device interactions to anomaly indicators.

As indicated above, in one or more embodiments, the anomalous-event-detection system 106 also utilizes an alert threshold to determine whether to provide an electronic communication (or perform a remedial action) for a detected anomalous action. For instance, FIG. 7 illustrates the anomalous-event-detection system 106 utilizing an alert threshold 718 to determine whether to provide an electronic communication (or perform a remedial action) for a detected anomalous action. In particular, the anomalous-event-detection system 106 can utilize one or both of a sensitivity level 720 and a severity level 722 to determine whether the alert threshold 718 is satisfied for the anomaly indicator 708 and anomalous action type. If the alert threshold 718 is satisfied by the anomaly indicator 708 and anomalous action type, the anomalous-event-detection system 106 can provide the electronic communication including the anomalous action alert to the administrator device 710 and/or perform a remedial action 724.

For instance, the sensitivity level 720 can represent a threshold confidence level that is to be satisfied by the anomaly-detection model 706 before the anomalous-event-detection system 106 can initiate an action (e.g., an anomalous action alert, a remedial action) based on the generated anomaly indicator. In one or more embodiments, the anomalous-event-detection system 106 can utilize a threshold confidence score as the sensitivity level. The anomalous-event-detection system 106 can compare the sensitivity level to a confidence score generated by an anomaly-detection model to determine whether the sensitivity level is satisfied. For example, if an anomaly-detection model generates a confidence score that satisfies a threshold confidence score as the sensitivity level, the anomalous-event-detection system 106 can determine that the anomaly indicator is a true positive anomaly detection. Moreover, if the anomaly-detection model generates a confidence score that does not satisfy a threshold confidence score, the anomalous-event-detection system 106 can determine that the anomaly indicator is a false positive anomaly detection.

In contrast to the sensitivity level 720, the severity level 722 can represent an importance of the detected anomalous action in terms of impact and/or harmfulness of the anomalous action. In particular, the anomalous-event-detection system 106 can utilize a severity level to determine whether the anomalous action represented by an anomaly indicator is considered harmful and/or significant to an administrator account of an administrator device. In some embodiments, the anomalous-event-detection system 106 determines a severity level of an anomalous action by utilizing an anomaly action type as a trigger for determining varying severity levels. For instance, the anomalous-event-detection system 106 can utilize varying severity levels based on severity levels assigned to particular anomaly action types. As an example, the anomalous-event-detection system 106 can determine that an anomaly action type of an anomalous mass file deletion has a high severity level and that an anomalous file metadata modification has a low severity level.

In some embodiments, the anomalous-event-detection system 106 can assign a severity score to one or more anomalous action types based on historical reactions to the anomalous action types from an administrator device. For example, the anomalous-event-detection system 106 can assign an increasingly higher severity score for an anomalous action type that increasingly receives an interaction from the administrator device (e.g., a high interaction rate). Moreover, the anomalous-event-detection system 106 can assign an increasingly lower severity score for an anomalous action type that does not receive an interaction from the administrator device (e.g., a low interaction rate).

In one or more embodiments, the anomalous-event-detection system 106 can also utilize a magnitude of an anomalous action to assign a severity level. For example, the anomalous-event-detection system 106 can assign an increasingly higher severity score as a number of digital content items affected by an anomalous action increases. To illustrate, the anomalous-event-detection system 106 can assign a high severity score to an anomalous mass file deletion (e.g., a large number of files) and a lower severity score to an anomalous file deletion of a singular file.

In some embodiments, the anomalous-event-detection system 106 can utilize a machine-learning model to classify an anomalous action (or anomalous action alert) with a severity score. In particular, the anomalous-event-detection system 106 can utilizes a machine-learning model that is trained to detect a severity of an anomalous action (or anomalous action alert) based on characteristics of the digital action, a user account, historical reactions to the anomalous action, and/or an organization corresponding to the user account. In some embodiments, the anomalous-event-detection system 106 can also utilize a machine-learning model that is trained to detect a severity of a digital action based on characteristics of an aggregate of files and content of a user account (or organization) compared to the number of digital content items affected by the digital action.

Upon generating an anomaly indicator from a digital action, the anomalous-event-detection system 106 can identify a severity score that corresponds to the anomalous action type. Then, the anomalous-event-detection system 106 can compare the severity score to the threshold severity score. When the severity score satisfies the threshold severity score, the anomalous-event-detection system 106 can determine that the detected anomalous action is substantial and can perform an action based on the detected anomalous action (e.g., transmit an alert and/or perform a remedial action). Additionally, when the severity score does not satisfy the threshold severity score, the anomalous-event-detection system 106 can determine that the detected anomalous action is not substantial and forego performing an action based on the detected anomalous action.

In some instances, the anomalous-event-detection system 106 can determine that an anomaly indicator and anomalous action type satisfies an alert threshold by determining that the anomaly indicator satisfies both the sensitivity level and the severity level. In some cases, the anomalous-event-detection system 106 can determine that the anomaly indicator anomalous action type satisfies the alert threshold by determining that the anomaly indicator satisfies at least one of the sensitivity level or the severity level. Upon determining that the alert threshold is satisfied, the anomalous-event-detection system 106 can transmit an alert for the detected anomalous action and/or perform a remedial action based on the detected anomalous action.

Furthermore, in some embodiments, the anomalous-event-detection system 106 can utilize administrator device interactions (in response to a detected anomalous action) to adjust a sensitivity and/or severity level. To illustrate, the anomalous-event-detection system 106 can increase the sensitivity level and/or the severity level as the administrator device interactions increasingly fail to react to anomalous actions (e.g., to decrease the number of false positive detections). In addition, the anomalous-event-detection system 106 can decrease the sensitivity level and/or the severity level as the administrator device interactions increasingly react to anomalous actions. In particular, decreasing the sensitivity level and/or the severity level can allow more detected anomalous action to reach an administrator device.

As previously mentioned, the anomalous-event-detection system 106 can, upon detecting an anomalous action, display electronic communications that indicate a digital action as anomalous within an administrator device. Furthermore, the anomalous-event-detection system 106 can provide selectable options to respond to an anomalous action within an administrator device. For example, FIG. 8 illustrates the anomalous-event-detection system 106 providing, for display within a graphical user interface, anomalous action alerts and selectable options for anomalous actions upon detecting anomalous actions.

As shown in FIG. 8, the anomalous-event-detection system 106 provides, for display within a graphical user interface 804 of an administrator device 802, an electronic communication 806 that indicates a digital action as anomalous. In particular, the electronic communication 806 indicates that an anomalous file deletion by a user 1 was detected. In addition, the anomalous-event-detection system 106 provides, for display within the graphical user interface 804 of the administrator device 802, selectable options 808-812. For example, the anomalous-event-detection system 106 can display details for the anomalous action upon detecting a selection of the selectable option 808, can recover the deleted files upon detecting a selection of the selectable option 810, and/or can restrict additional actions from user 1 upon detecting a selection of the selectable option 812.

As also shown in FIG. 8, the anomalous-event-detection system 106 can provide, for display within the graphical user interface 804 of the administrator device 802, an electronic communication 814 that indicates an additional digital action as anomalous. Specifically, the electronic communication 814 indicates that an anomalous file share by a user 4 was detected. Moreover, the anomalous-event-detection system 106 provides, for display within the graphical user interface 804 of the administrator device 802, selectable options 816-820. As with the previous selection options, in one or more embodiments, the anomalous-event-detection system 106 can display details for the anomalous action upon detecting a selection of the selectable option 816, can remove share permissions of user 4 upon detecting a selection of the selectable option 818, and/or can restrict additional actions from user 4 upon detecting a selection of the selectable option 820.

As noted above, the anomalous-event-detection system 106 can provide options for alerts or remedial actions. For example, in some embodiments, the anomalous-event-detection system 106 provides a selectable option to filter or reorganize displayed anomalous alerts based on a severity and/or sensitivity level. For instance, the anomalous-event-detection system 106 can receive a request to filter displayed anomalous alerts based on a severity level and/or sensitivity level (e.g., show alerts that exceed a severity and/or sensitivity level) and, in response, can remove, from display, alerts that do not meet the severity level and/or sensitivity level filter. Moreover, the anomalous-event-detection system 106 can also rearrange anomalous alerts based on a severity level and/or sensitivity level by rearranging the anomalous alerts based on a descending and/or ascending order of the severity level and/or sensitivity level.

In addition to such alert options, the anomalous-event-detection system 106 can also provide, for display within a graphical user interface of an administrator device, a severity label for an anomalous alert. For example, the anomalous-event-detection system 106 can utilize a severity score (or level) determined for an anomalous alert to label the anomalous alert with a severity label. To illustrate, the severity label can indicate whether the anomalous alert is a high severity alert and/or a low severity alert.

In addition to severity options, in some cases, the anomalous-event-detection system 106 provides, for display within a graphical user interface of an administrator device, digital content items corresponding to an anomalous action alert. For example, the anomalous-event-detection system 106 can display a visual preview of a digital content item that was affected by the anomalous action alert. In some instances, the anomalous-event-detection system 106 displays a visual preview of nested files corresponding to the anomalous action alert.

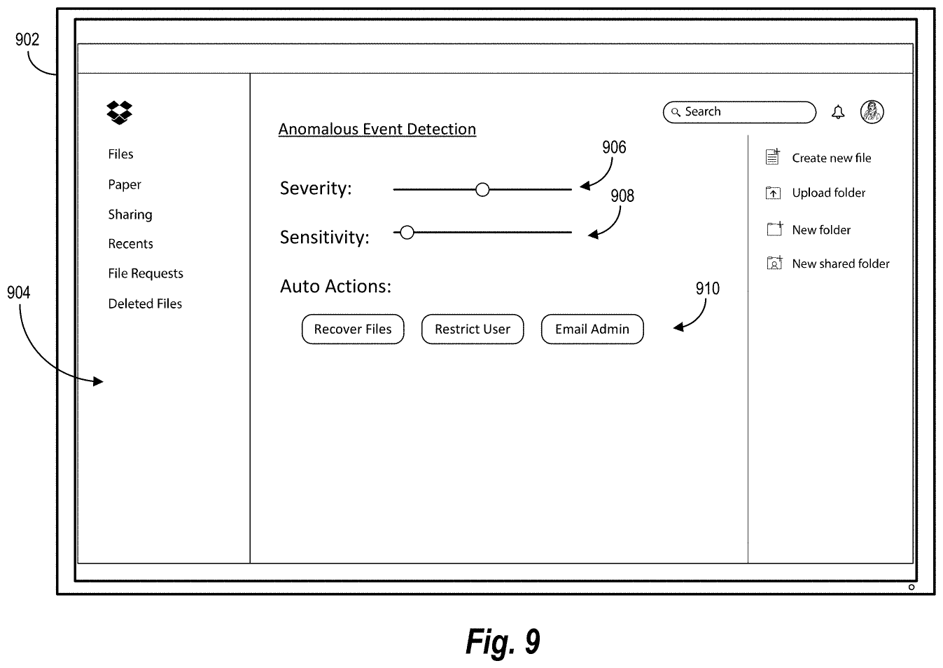

As further suggested above, in one or more embodiments, the anomalous-event-detection system 106 receives setting configurations from an administrator device. For example, FIG. 9 illustrates the anomalous-event-detection system 106 providing, for display within a graphical user interface 904 of an administrator device 902, selectable options to configure one or more settings of the anomalous-event-detection system 106. The anomalous-event-detection system 106 can utilize selections indicated on the graphical user interface 904 to configure how remedial actions are performed and/or how alerts are taken in response to detected anomalous actions.

For example, as shown in FIG. 9, the anomalous-event-detection system 106 can provide, for display within the graphical user interface 904 of the administrator device 902, a selectable option 906 to adjust a severity level. In particular, the anomalous-event-detection system 106 can receive an indication of a selection to change the severity level via the selectable option 906. Upon receiving the change to the severity level, the anomalous-event-detection system 106 modifies a severity threshold based on the selected severity level in the graphical user interface 904.

Moreover, as shown in FIG. 9, the anomalous-event-detection system 106 can provide, for display within the graphical user interface 904 of the administrator device 902, a selectable option 908 to adjust a sensitivity level. In one or more embodiments, the anomalous-event-detection system 106 receives an indication of a selection to change the sensitivity level via the selectable option 908. Upon receiving the change to the severity level, the anomalous-event-detection system 106 can modify a sensitivity threshold based on the selected sensitivity level in the graphical user interface 904.

In some embodiments, the anomalous-event-detection system 106 can utilize a machine-learning model to modify a sensitivity threshold. In particular, the anomalous-event-detection system 106 can utilize a machine-learning model that is trained to determine a sensitivity threshold based on characteristics of the digital action, a user account, historical reactions to anomalous actions, and/or an organization corresponding to the user account. In particular, the anomalous-event-detection system 106 can utilize the machine-learning model that is trained to determine a sensitivity threshold to modify the sensitivity threshold based on interaction data taken by administrator devices in response to transmitted anomalous action alerts.

In addition to severity or sensitivity options, in one or more embodiments, the anomalous-event-detection system 106 can provide, for display within the graphical user interface 904 of the administrator device 902, selectable options 910 to toggle remedial actions that can be automatically performed upon detecting an anomalous action. For example, upon receiving a selection of the “recover files” option from the selectable options 910, the anomalous-event-detection system 106 can automatically perform a file recovery upon detecting an anomalous file deletion and/or file transfer. When an auto action is not selected via the graphical user interface 904, the anomalous-event-detection system 106 can forego automatically performing the unselected auto action when an anomalous action is detected. Indeed, the anomalous-event-detection system 106 can provide selectable options to toggle auto remedial actions for a variety of remedial actions described herein.

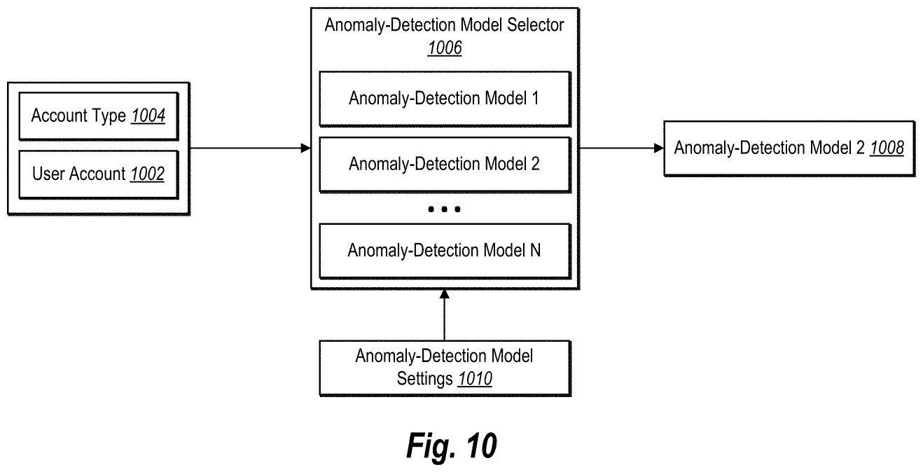

As suggested above, in some embodiments, the anomalous-event-detection system 106 can select between various anomaly-detection models based on a user account. For example, FIG. 10 illustrates the anomalous-event-detection system 106 selecting between a variety of anomaly-detection models based on a user account. Specifically, as shown in FIG. 10, the anomalous-event-detection system 106 can utilize a user account 1002 and/or an account type 1004 associated with the user account 1002 with an anomaly-detection model selector 1006 to select an anomaly-detection model 1008 (e.g., anomaly-detection model 2).

In particular, the anomalous-event-detection system 106 can match the user account 1002 and/or an account type 1004 associated with the user account 1002 with anomaly-detection model settings 1010 that indicate mappings between different types of user accounts and anomaly-detection models. Then, the anomalous-event-detection system 106 can select an anomaly-detection model from a variety of anomaly-detection models based on the appropriate mapping between the user account 1002 and/or the account type 1104. For example, in one or more embodiments, the anomalous-event-detection system 106 can identify that a first user account corresponds to an organization of software developers. Then, the anomalous-event-detection system 106 can match the first user to an anomaly-detection model that is trained to detect anomalous actions in a digital content management setting that is utilized by software developers. In addition, the anomalous-event-detection system 106 can identify that a second user account corresponds to an organization of hospital technicians. Subsequently, the anomalous-event-detection system 106 can match the second user to an anomaly-detection model that is trained to detect anomalous actions in a digital content management setting that is utilized by hospital technicians.

In some cases, the anomalous-event-detection system 106 can receive anomaly-detection model settings from an administrator device. For example, the anomalous-event-detection system 106 can receive a selection for which anomaly-detection model to utilize for a user account. In some cases, the anomalous-event-detection system 106 can match a user account to an anomaly-detection model based on characteristics of the user account and/or account type and various use cases corresponding to the anomaly-detection models. For example, the anomalous-event-detection system 106 can select an anomaly-detection model based on a type of an organization (e.g., health care, art studio, software developer) and/or a size of an organization (e.g., a small sized organization, medium sized organization, a large sized organization) corresponding to a user account.

In one or more embodiments, the anomalous-event-detection system 106 can utilize an account type associated with a user account to select an anomaly-detection model. In particular, an account type can include an account tier based on a subscription plan, based on a size of the account, and/or based on the frequency of activity on the account. Additionally, the anomalous-event-detection system 106 can also select an anomaly-detection model based on a group of the content management system 104 associated with a user account. For instance, the anomalous-event-detection system 106 can select between various anomaly-detection models based on characteristics of groups associated with the user account. As an example, the anomalous-event-detection system 106 can select between anomaly-detection models based on a size of a group, activity of a group, and/or known activity patterns of a group.

In one or more embodiments, the various selectable anomaly-detection models are generated by modifying anomaly-detection models based on specific user types of a user account, an account type associated with a user account, or a group of the content management system associated with a user account. More specifically, upon assigning user accounts corresponding to the user types, account types, and/or associated groups to specific anomaly-detection models, the anomalous-event-detection system 106 can receive interaction data from the assigned user accounts to specifically modify (or train) the corresponding anomaly-detection models. Accordingly, the various anomaly-detection models can be trained using detected anomalous actions and interactions in response to anomalous actions from user accounts that belong to the specific user types, account types, and/or associated groups.

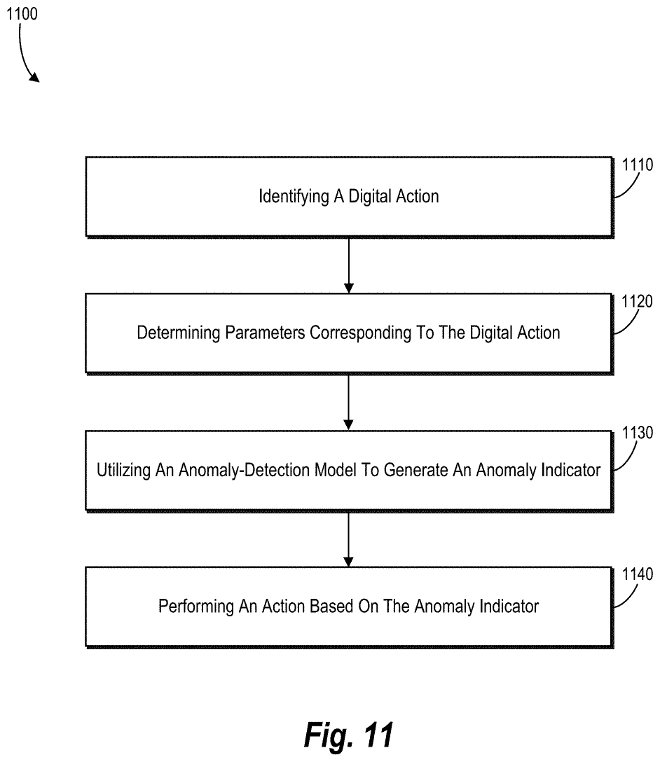

FIGS. 1-10, the corresponding text, and the examples provide a number of different methods, systems, devices, and non-transitory computer-readable media of the anomalous-event-detection system 106. In addition to the foregoing, one or more implementations can also be described in terms of flowcharts comprising acts for accomplishing a particular result, as shown in FIG. 11. The acts shown in FIG. 11 may be performed in connection with more or fewer acts. Further, the acts may be performed in differing orders. Additionally, the acts described herein may be repeated or performed in parallel with one another or parallel with different instances of the same or similar acts. A non-transitory computer-readable medium can comprise instructions that, when executed by one or more processors, cause a computing device to perform the acts of FIG. 11. In some implementations, a system can be configured to perform the acts of FIG. 11. Alternatively, the acts of FIG. 11 can be performed as part of a computer-implemented method.

FIG. 11 illustrates a flowchart of a series of acts 1100 for detecting and reacting to anomalous digital actions in accordance with one or more implementations. While FIG. 11 illustrates acts according to one implementation, alternative implementations may omit, add to, reorder, and/or modify any of the acts shown in FIG. 11.

As shown in FIG. 11, the series of acts 1100 include an act 1110 of identifying a digital action. For example, the act 1110 can include identifying a digital action taken by a client device associated with a user account of a content management system. In some embodiments, the act 1110 includes identifying a digital action taken by a client device via a document-synchronizing platform through which multiple user accounts access, edit, or share synchronized documents.

Furthermore, as shown in FIG. 11, the series of acts 1100 include an act 1120 of determining parameters corresponding to a digital action. In particular, the act 1120 can include determining a set of parameters corresponding to a digital action. For example, a parameter can include at least one of a type of digital action, a number of affected files, a file size, a user location, a time of the digital action, collaborator data, or a user role. Furthermore, a parameter can also include at least one of collaborator activity, a collaborator identity, personal identifiable information (PII) classification, a confidentiality classification, a time zone of a digital action, a time of user interactivity with a digital content item, historical user activity times within a digital content management system, user engagement data, a user device type, a user e-mail domain, user group similarity data, or user activity patterns.

As further shown in FIG. 11, the series of acts 1100 include an act 1130 of utilizing an anomaly-detection model to generate an anomaly indicator. In particular, the act 1130 can include utilizing an anomaly-detection model trained to detect anomalous actions to generate an anomaly indicator corresponding to a digital action based on a set of parameters (of the digital action). In some embodiments, the act 1130 can include modifying an anomaly-detection model based on data indicating the response for at least one of a user type for a user account, an account type associated with the user account, or a group of a content management system associated with the user account.

Furthermore, as shown in FIG. 11, the series of acts 1100 include an act 1140 of performing an action based on the anomaly indicator. In particular, the act 1140 can include, based on an anomaly indicator, providing, for display on a graphical user interface of an administrator device, an electronic communication indicating a digital action as anomalous. For instance, the act 1140 can include providing, for display on a graphical user interface of an administrator device, an electronic communication to indicate a digital action includes at least one of an anomalous file deletion, an anomalous file share, an anomalous file creation, an anomalous file modification, an anomalous user role modification, or an anomalous file decryption. In addition, the act 1140 can include providing, for display on a graphical user interface of an administrator device, a context for identifying a digital action as anomalous, the context including an indicator of at least one of a user account corresponding to a digital action, a time of the digital action, or a reason for identifying the digital action as anomalous.

Moreover, the act 1140 can include providing an electronic communication indicating a digital action as anomalous based on a digital action satisfying an alert threshold representing one or more of a severity level of the digital action or a sensitivity level of the anomaly indicator from the anomaly-detection model (e.g., the anomaly indicator indicating that the digital action is an anomalous action). Furthermore, the act 1140 can include determining a severity level of a digital action based on at least one of a set of parameters corresponding to the digital action, characteristics corresponding to a user account of a content management system, or user interactions corresponding to historical electronic communications indicating digital actions as anomalous. In addition, the act 1140 can include indicating a digital action as anomalous based on the digital action satisfying an alert threshold representing a severity level of the digital action.

Additionally, the act 1140 can include performing a remedial action within a content management system in response to an anomalous action. Moreover, the act 1140 can include performing a remedial action by automatically recovering one or more deleted digital content items, restricting a user account corresponding to a digital action from performing additional digital actions, or modifying a user permission of a user account. In some instances, the act 1140 can include providing, for display on a graphical user interface of an administrator device, an electronic communication to indicate a performed remedial action. Additionally, the act 1140 can include providing, for display on a graphical user interface of an administrator device, a selectable option to cancel a remedial action. In some embodiments, the act 1140 can include performing a remedial action based on a severity level of a digital action.

Furthermore, the act 1140 can include modifying an anomaly-detection model based on data received from an administrator device indicating a response to an electronic communication or a digital action. In some embodiments, the act 1140 can include modifying an anomaly-detection model by adjusting parameters of a machine learning model. For example, a machine learning model can include a neural network model, a cluster model, or a random forest model. In some embodiments, the act 1140 can include training a machine learning model based on data received from administrator devices comprising characteristics corresponding to a group of users within the content management system. In certain instances, the act 1140 can include providing, for display on a graphical user interface of an administrator device, a selectable option for a remedial action in response to the digital action and modifying an anomaly-detection model based on receiving, from the administrator device, a selection of the selectable option for remedial action or no selection of the selectable option for the remedial action.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates a block diagram of exemplary computing device 1200 that may be configured to perform one or more of the processes described above. One will appreciate that server device(s) 102, client devices 112a-112n, and/or administrator device 116 may comprise one or more computing devices such as computing device 1200. As shown by FIG. 12, computing device 1200 can comprise processor 1202, memory 1204, storage device 1206, I/O interface 1208, and communication interface 1210, which may be communicatively coupled by way of communication infrastructure 1212. While an exemplary computing device 1200 is shown in FIG. 12, the components illustrated in FIG. 12 are not intended to be limiting. Additional or alternative components may be used in other embodiments. Furthermore, in certain embodiments, computing device 1200 can include fewer components than those shown in FIG. 12. Components of computing device 1200 shown in FIG. 12 will now be described in additional detail.

In particular embodiments, processor 1202 includes hardware for executing instructions, such as those making up a computer program. As an example and not by way of limitation, to execute instructions, processor 1202 may retrieve (or fetch) the instructions from an internal register, an internal cache, memory 1204, or storage device 1206 and decode and execute them. In particular embodiments, processor 1202 may include one or more internal caches for data, instructions, or addresses. As an example and not by way of limitation, processor 1202 may include one or more instruction caches, one or more data caches, and one or more translation lookaside buffers (TLBs). Instructions in the instruction caches may be copies of instructions in memory 1204 or storage device 1206.

Memory 1204 may be used for storing data, metadata, and programs for execution by the processor(s). Memory 1204 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1204 may be internal or distributed memory.

Storage device 1206 includes storage for storing data or instructions. As an example and not by way of limitation, storage device 1206 can comprise a non-transitory storage medium described above. Storage device 1206 may include a hard disk drive (HDD), a floppy disk drive, flash memory, an optical disc, a magneto-optical disc, magnetic tape, or a Universal Serial Bus (USB) drive or a combination of two or more of these. Storage device 1206 may include removable or non-removable (or fixed) media, where appropriate. Storage device 1206 may be internal or external to computing device 1200. In particular embodiments, storage device 1206 is non-volatile, solid-state memory. In other embodiments, Storage device 1206 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1208 allows a user to provide input to, receive output from, and otherwise transfer data to and receive data from computing device 1200. I/O interface 1208 may include a mouse, a keypad or a keyboard, a touch screen, a camera, an optical scanner, network interface, modem, other known I/O devices or a combination of such I/O interfaces. I/O interface 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interface 1208 is configured to provide graphical data to a display for presentation to a user. The graphical data may be representative of one or more graphical user interfaces and/or any other graphical content as may serve a particular implementation.

Communication interface 1210 can include hardware, software, or both. In any event, communication interface 1210 can provide one or more interfaces for communication (such as, for example, packet-based communication) between computing device 1200 and one or more other computing devices or networks. As an example and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI.

Additionally, or alternatively, communication interface 1210 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1210 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1210 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1212 may include hardware, software, or both that couples components of computing device 1200 to each other. As an example and not by way of limitation, communication infrastructure 1212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 13 is a schematic diagram illustrating environment 1300 within which one or more embodiments of content management system 104 can be implemented. Online content management system 1302 may generate, store, manage, receive, and send digital content (such as digital videos). For example, online content management system 1302 may send and receive digital content to and from client devices 1306 by way of network 1304. In particular, online content management system 1302 can store and manage a collection of digital content. Online content management system 1302 can manage the sharing of digital content between computing devices associated with a plurality of users. For instance, online content management system 1302 can facilitate a user sharing a digital content with another user of online content management system 1302.

In particular, online content management system 1302 can manage synchronizing digital content across multiple client devices 1306 associated with one or more users. For example, a user may edit digital content using client device 1306. The online content management system 1302 can cause client device 1306 to send the edited digital content to online content management system 1302. Online content management system 1302 then synchronizes the edited digital content on one or more additional computing devices.

In addition to synchronizing digital content across multiple devices, one or more embodiments of online content management system 1302 can provide an efficient storage option for users that have large collections of digital content. For example, online content management system 1302 can store a collection of digital content on online content management system 1302, while the client device 1306 only stores reduced-sized versions of the digital content. A user can navigate and browse the reduced-sized versions (e.g., a thumbnail of a digital image) of the digital content on client device 1306. In particular, one way in which a user can experience digital content is to browse the reduced-sized versions of the digital content on client device 1306.

Another way in which a user can experience digital content is to select a reduced-size version of digital content to request the full- or high-resolution version of digital content from online content management system 1302. In particular, upon a user selecting a reduced-sized version of digital content, client device 1306 sends a request to online content management system 1302 requesting the digital content associated with the reduced-sized version of the digital content. Online content management system 1302 can respond to the request by sending the digital content to client device 1306. Client device 1306, upon receiving the digital content, can then present the digital content to the user. In this way, a user can have access to large collections of digital content while minimizing the number of resources used on client device 1306.

Client device 1306 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 1306 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox for iPhone or iPad, Dropbox for Android, etc.), to access and view content over network 1304.

Network 1304 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1306 may access online content management system 1302.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A non-transitory computer-readable medium storing instructions that, when executed by at least one processor, cause a computing system to:
identify a digital action taken by a client device associated with a user account of a content management system;
determine a set of parameters corresponding to the digital action comprising at least one of a type of digital action, a number of affected files, a file size, a user location, a time of the digital action, collaborator data, or a user role;
based on the set of parameters, utilize an anomaly-detection model trained to detect anomalous actions to generate an anomaly indicator corresponding to the digital action; and
based on the anomaly indicator, provide, for display on a graphical user interface of an administrator device, an electronic communication indicating the digital action as anomalous.

2. The non-transitory computer-readable medium of claim 1, further comprising instructions that, when executed by the at least one processor, cause the computing system to identify the digital action taken by the client device via a document-synchronizing platform through which multiple user accounts access, edit, or share synchronized documents.

3. The non-transitory computer-readable medium of claim 1, further comprising instructions that, when executed by the at least one processor, cause the computing device to provide, for display on the graphical user interface of the administrator device, the electronic communication to indicate the digital action comprises at least one of an anomalous file deletion, an anomalous file share, an anomalous file creation, an anomalous file modification, an anomalous user role modification, or an anomalous file decryption.

4. The non-transitory computer-readable medium of claim 1, further comprising instructions that, when executed by the at least one processor, cause the computing device to provide, for display on the graphical user interface of the administrator device, a context for identifying the digital action as anomalous, the context including an indicator of at least one of the user account corresponding to the digital action, a time of the digital action, or a reason for identifying the digital action as anomalous.

5. The non-transitory computer-readable medium of claim 1, further comprising instructions that, when executed by the at least one processor, cause the computing system to provide the electronic communication indicating the digital action as anomalous based on the digital action satisfying an alert threshold representing one or more of a severity level of the digital action or a sensitivity level of the anomaly indicator from the anomaly-detection model.

6. The non-transitory computer-readable medium of claim 5, further comprising instructions that, when executed by the at least one processor, cause the computing system to determine the severity level of the digital action based on at least one of the set of parameters corresponding to the digital action, characteristics corresponding to the user account of the content management system, or user interactions corresponding to historical electronic communications indicating digital actions as anomalous.

7. The non-transitory computer-readable medium of claim 1, wherein the set of parameters corresponding to the digital action further comprise at least one of collaborator activity, a collaborator identity, a personal identifiable information (PII) classification, a time zone of the digital action, a time of user interactivity with a digital content item, historical user activity times within the content management system, user engagement data, a user device type, a user e-mail domain, user group similarity data, or user activity patterns.

8. A system comprising:
at least one processor; and
at least one non-transitory computer-readable storage medium storing instructions that, when executed by the at least one processor, cause the system to:
identify a digital action taken by a client device associated with a user account of a content management system;
determine a set of parameters corresponding to the digital action comprising at least one of a type of digital action, a number of affected files, a file size, a user location, a time of the digital action, collaborator data, or a user role;
based on the set of parameters, utilize an anomaly-detection model trained to detect anomalous actions to generate an anomaly indicator corresponding to the digital action; and
perform a remedial action within the content management system in response to the anomaly indicator identifying the digital action as anomalous.

9. The system of claim 8, further comprising instructions that, when executed by the at least one processor, cause the system to, provide, for display on a graphical user interface of an administrator device, an electronic communication to indicate the digital action comprises at least one of an anomalous file deletion, an anomalous file share, an anomalous file creation, an anomalous file modification, an anomalous user role modification, or an anomalous file decryption.

10. The system of claim 8, further comprising instructions that, when executed by the at least one processor, cause the system to perform the remedial action by automatically recovering one or more deleted digital content items, restricting the user account corresponding to the digital action from performing additional digital actions, or modifying a user permission of the user account.

11. The system of claim 8, further comprising instructions that, when executed by the at least one processor, cause the system to provide, for display on a graphical user interface of an administrator device, an electronic communication to indicate the performed remedial action.

12. The system of claim 11, further comprising instructions that, when executed by the at least one processor, cause the system to provide, for display on the graphical user interface of the administrator device, a selectable option to cancel the remedial action.

13. The system of claim 8, further comprising instructions that, when executed by the at least one processor, cause the system to indicate the digital action as anomalous based on the digital action satisfying an alert threshold representing a severity level of the digital action.

14. The system of claim 13, further comprising instructions that, when executed by the at least one processor, cause the system to perform the remedial action based on the severity level of the digital action.

15. A computer-implemented method comprising:
identifying a digital action taken by a client device of a user account of a content management system;
determining a set of parameters corresponding to the digital action comprising at least one of a type of digital action, a number of affected files, a file size, a user location, a time of the digital action, collaborator data, or a user role;
based on the set of parameters, utilizing an anomaly-detection model trained to detect anomalous actions to generate an anomaly indicator corresponding to the digital action;
based on the anomaly indicator, providing, for display on a graphical user interface of an administrator device, an electronic communication indicating the digital action as anomalous; and
modifying the anomaly-detection model based on data received from the administrator device indicating a response to the electronic communication or the digital action.

16. The computer-implemented method of claim 15, wherein providing the electronic communication comprises providing the electronic communication to indicate the digital action comprises at least one of an anomalous file deletion, an anomalous file share, an anomalous file creation, an anomalous file modification, an anomalous user role modification, or an anomalous file decryption.

17. The computer-implemented method of claim 15, wherein modifying the anomaly-detection model comprises adjusting parameters of a machine learning model.

18. The computer-implemented method of claim 17, further comprising training the machine learning model based on data received from administrator devices comprising characteristics corresponding to a group of users within the content management system.

19. The computer-implemented method of claim 15, further comprising:
providing, for display on the graphical user interface of the administrator device, a selectable option for a remedial action in response to the digital action; and
modifying the anomaly-detection model based on receiving, from the administrator device, a selection of the selectable option for the remedial action or no selection of the selectable option for the remedial action.

20. The computer-implemented method of claim 15, wherein modifying the anomaly-detection model comprises modifying the anomaly-detection model based on data indicating the response for at least one of a user type for the user account, an account type associated with the user account, or a group of the content management system associated with the user account.
